(19) United States
(12) Patent Application Publication
(10) Pub. No.: US 2025/0170868 A1
(43) Pub. Date: May 29, 2025

(54) VEHICLE AND HEAT MANAGEMENT SYSTEM

(71) Applicant: Panasonic Automotive Systems Co., Ltd., Kanagawa (JP)

(72) Inventors: Katsuji TANIGUCHI, Kanagawa (JP); Yuki MAKITA, Kanagawa (JP); Yoshitoshi NODA, Kanagawa (JP)

(73) Assignee: Panasonic Automotive Systems Co., Ltd., Kanagawa (JP)

(21) Appl. No.: 19/040,143

(22) Filed: Jan. 29, 2025

Related U.S. Application Data
(63) Continuation of application No. PCT/JP2023/032042, filed on Aug. 31, 2023.

(30) Foreign Application Priority Data
Oct. 24, 2022 (JP) 2022-170010
Oct. 24, 2022 (JP) 2022-170011

(51) Int. Cl. B60H 1/00; B60L 50/60; B60L 58/26; H01M 10/613; H01M 10/625; H01M 10/6556; H01M 10/663

(52) U.S. Cl. CPC B60H 1/00278; B60H 1/00342; B60H 1/00921; B60L 50/60; H01M 10/613; H01M 10/625; H01M 10/6556; H01M 10/663; B60H 2001/00307; B60H 2001/00928; B60L 58/26; H01M 2220/20

(57) ABSTRACT

A vehicle includes a secondary battery, a heat exchange plate, a compressor, a vehicle interior condenser capable of exchanging heat with air in a vehicle interior, and a refrigerant circuit in which a refrigerant is movable between the compressor and the vehicle interior condenser. The refrigerant is capable of exchanging heat with a coolant in the heat exchange plate, and the heat exchange plate is capable of exchanging heat with the secondary battery. The coolant that has exited from the heat exchange plate can circulate and enter the heat exchange plate. The refrigerant moves through the refrigerant circuit and circulates through the compressor, the vehicle interior condenser, the heat exchange plate, and the compressor to warm the air in the vehicle interior using heat generated by the secondary battery.

### CROSS-REFERENCE TO RELATED APPLICATIONS

The present application is a continuation application of PCT/JP2023/032042 that claims priority to Japanese Patent Application No. 2022-170010 filed on Oct. 24, 2022 and Japanese Patent Application No. 2022-170011 filed on Oct. 24, 2022, the entire contents of which are incorporated herein by reference.

### TECHNICAL FIELD

The present disclosure relates to a vehicle and a heat management system.

### BACKGROUND ART

U.S. Pat. No. 8,402,776B discloses a configuration including a drive system cooling circuit and a battery cooling circuit, which are connected via a four-way valve, and includes a common reservoir tank. US2021/0031588A discloses that a system in which cooling and heating are performed using a refrigerant and a battery is cooled with water cooled by the refrigerant has a mode in which the battery and air are heated using water heated by a water heater.

A vehicle including a secondary battery such as a battery electric vehicle (BEV), a plug-in hybrid vehicle (PHEV), or a hybrid vehicle (HEV) is provided with a heat exchange plate for temperature control of the secondary battery. A hybrid type heat exchange plate using a refrigerant and a coolant is known as the heat exchange plate. Further, the vehicle includes a vehicle interior air conditioner that heats or cools air in a vehicle interior, and the vehicle interior air conditioner also uses the refrigerant.

### SUMMARY OF INVENTION

The present disclosure provides a vehicle and a heat management system that can appropriately share a refrigerant between a hybrid type heat exchange plate and a vehicle interior air conditioner.

An aspect of the present disclosure provides a vehicle including:
a vehicle body;
a vehicle interior disposed inside the vehicle body;
a first wheel and a second wheel coupled to the vehicle body;
a secondary battery disposed along a predetermined plane in the vehicle body;
a heat exchange plate disposed along the predetermined plane in the vehicle body;
an electric motor configured to drive at least the first wheel using electric power supplied from the secondary battery; and
a refrigerant circuit which includes at least a compressor and a vehicle interior condenser capable of exchanging heat with air in the vehicle interior, and in which a refrigerant is movable between the compressor and the vehicle interior condenser, in which
the heat exchange plate includes:
   a refrigerant input portion that allows the refrigerant that has exited from the vehicle interior condenser of the refrigerant circuit to enter the heat exchange plate and a refrigerant output portion that allows the refrigerant to enter the compressor from the heat exchange plate; and
   a first coolant input and output portion that allows a coolant to be input to and output from the heat exchange plate, and a second coolant input and output portion that allows the coolant to be input to and output from the heat exchange plate,
in the heat exchange plate, the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the coolant that has exited from the first coolant input and output portion of the heat exchange plate is capable of entering the second coolant input and output portion, and
the refrigerant circulates through at least the compressor, the vehicle interior condenser, the heat exchange plate, and the compressor, such that heat generated by the secondary battery is used to warm the air in the vehicle interior.

An aspect of the present disclosure provides a heat management system mountable on a vehicle,
the vehicle including:
a vehicle body;
a vehicle interior disposed inside the vehicle body;
a first wheel and a second wheel coupled to the vehicle body;
a secondary battery disposed along a predetermined plane in the vehicle body; and
an electric motor that drives at least the first wheel using electric power supplied from the secondary battery,
the heat management system including:
a heat exchange plate disposed along the predetermined plane in the vehicle body; and
a refrigerant circuit which includes at least a compressor and a vehicle interior condenser capable of exchanging heat with air in the vehicle interior, and in which a refrigerant is movable between the compressor and the vehicle interior condenser, in which
the heat exchange plate includes:
   a refrigerant input portion that allows the refrigerant that has exited from the vehicle interior condenser of the refrigerant circuit to enter the heat exchange plate and a refrigerant output portion that allows the refrigerant to enter the compressor from the heat exchange plate; and
   a first coolant input and output portion that allows a coolant to be input to and output from the heat exchange plate, and a second coolant input and output portion that allows the coolant to be input to and output from the heat exchange plate,
the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the coolant that has exited from the first coolant input and output portion of the heat exchange plate is capable of entering the second coolant input and output portion, and
the refrigerant circulates through at least the compressor, the vehicle interior condenser, the heat exchange plate, and the compressor, such that heat generated by the secondary battery is used to warm the air in the vehicle interior.

According to the present disclosure, it is possible to appropriately share a refrigerant between a hybrid type heat exchange plate and a vehicle interior air conditioner.

### BRIEF DESCRIPTION OF DRAWINGS

FIG. 1 is a plan view showing a configuration example of a vehicle according to an embodiment of the present disclosure;

FIG. 2 is a left side view showing the configuration example of the vehicle according to the embodiment of the present disclosure;

FIG. 3 is a diagram showing an example of an electric circuit provided in the vehicle according to the embodiment of the present disclosure;

FIG. 4 is a perspective view showing a configuration example of a battery pack according to the embodiment of the present disclosure;

FIG. 5 is a cross-sectional view taken along a line A-A of the battery pack shown in FIG. 4;

FIG. 6 is a diagram showing a first configuration example of a heat management system according to a first embodiment;

FIG. 7 is a diagram illustrating a first operation pattern of the heat management system when heating is performed in a vehicle interior according to the first configuration example;

FIG. 8 is a diagram illustrating a second operation pattern of the heat management system when the heating is performed in the vehicle interior according to the first configuration example;

FIG. 9 is a diagram illustrating a third operation pattern of the heat management system when the heating is performed in the vehicle interior according to the first configuration example;

FIG. 10 is a diagram illustrating a fourth operation pattern of the heat management system when the heating is performed in the vehicle interior according to the first configuration example;

FIG. 11 is a diagram illustrating a fifth operation pattern of the heat management system when the heating is performed in the vehicle interior according to the first configuration example;

FIG. 12 is a diagram illustrating a sixth operation pattern of the heat management system when the heating is performed in the vehicle interior according to the first configuration example;

FIG. 13 is a diagram illustrating an operation pattern of the heat management system when cooling is performed in the vehicle interior according to the first configuration example;

FIG. 14 is a diagram illustrating a first operation pattern of the heat management system when a secondary battery is warmed according to the first configuration example;

FIG. 15 is a diagram illustrating a second operation pattern of the heat management system when the secondary battery is warmed according to the first configuration example;

FIG. 16 is a diagram illustrating an operation pattern of the heat management system when the secondary battery is cooled according to the first configuration example;

FIG. 17 is a diagram showing a second configuration example of the heat management system according to the first embodiment;

FIG. 18 is a diagram illustrating a first operation pattern of the heat management system when the heating is performed in the vehicle interior according to the second configuration example;

FIG. 19 is a diagram illustrating a second operation pattern of the heat management system when the heating is performed in the vehicle interior according to the second configuration example;

FIG. 20 is a diagram illustrating a third operation pattern of the heat management system when the heating is performed in the vehicle interior according to the second configuration example;

FIG. 21 is a diagram illustrating a fourth operation pattern of the heat management system when the heating is performed in the vehicle interior according to the second configuration example;

20 FIG. 22 is a diagram illustrating an operation pattern of the heat management system when the cooling is performed in the vehicle interior according to the second configuration example;

FIG. 23 is a diagram illustrating a first operation pattern of the heat management system when the secondary battery is warmed according to the second configuration example;

FIG. 24 is a diagram illustrating a second operation pattern of the heat management system when the secondary battery is warmed according to the second configuration example;

FIG. 25 is a diagram illustrating an operation pattern of the heat management system when the secondary battery is cooled according to the second configuration example;

FIG. 26 is a diagram showing a third configuration example of the heat management system according to the first embodiment;

FIG. 27 is a diagram illustrating a first operation pattern of the heat management system when the heating is performed in the vehicle interior according to the third configuration example;

FIG. 28 is a diagram illustrating a second operation pattern of the heat management system when the heating is performed in the vehicle interior according to the third configuration example;

FIG. 29 is a diagram illustrating a third operation pattern of the heat management system when the heating is performed in the vehicle interior according to the third configuration example;

FIG. 30 is a diagram illustrating a fourth operation pattern of the heat management system when the heating is performed in the vehicle interior according to the third configuration example;

FIG. 31 is a diagram illustrating an operation pattern of the heat management system when the cooling is performed in the vehicle interior according to the third configuration example;

FIG. 32 is a diagram illustrating a first operation pattern of the heat management system when the secondary battery is warmed according to the third configuration example;

FIG. 33 is a diagram illustrating a second operation pattern of the heat management system when the secondary battery is warmed according to the third configuration example;

FIG. 34 is a diagram illustrating an operation pattern of the heat management system when the secondary battery is cooled according to the third configuration example;

FIG. 35 is a diagram showing a configuration example including an ECU and the like in the heat management system according to the second configuration example;

FIG. 36 is a flowchart showing an example of a process performed by the ECU of the heat management system according to the first embodiment;

FIG. 37 is a diagram showing a configuration example of a heat management system according to a second embodiment;

FIGS. 38A to 38D are a diagram illustrating a discharge timing of a refrigerant according to the second embodiment;

FIG. 39 is a flowchart showing an example of a process performed by the ECU of the heat management system according to the second embodiment; and

FIG. 40 is a diagram showing a modification of a configuration of the heat management system according to the second embodiment.

### DESCRIPTION OF EMBODIMENTS

Hereinafter, embodiments of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, and are not intended to limit the subject matter described in claims.

### EMBODIMENTS OF PRESENT DISCLOSURE

### Configuration of Vehicle

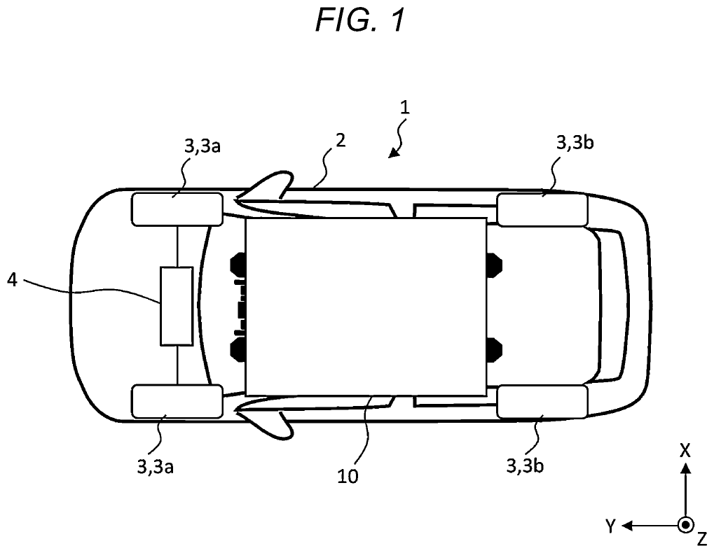

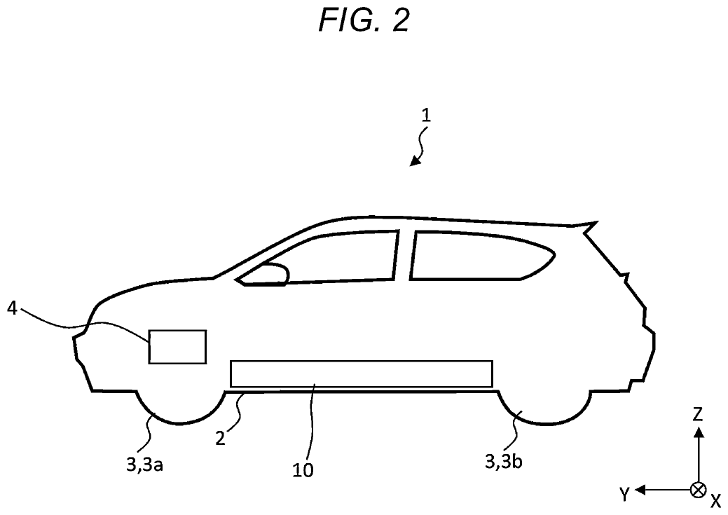

FIG. 1 is a plan view showing a configuration example of a vehicle 1 according to an embodiment of the present disclosure. FIG. 2 is a left side view showing the configuration example of the vehicle 1 according to the embodiment of the present disclosure.

For convenience of description, as shown in FIGS. 1 and 2, an axis extending in a height direction of the vehicle 1 is taken as a Z axis. An axis perpendicular to the Z axis (that is, parallel to ground) and extending in a traveling direction of the vehicle 1 is taken as a Y axis. An axis perpendicular to the Y axis and the Z axis (that is, an axis in a width direction of the vehicle 1) is taken as an X axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. These expressions are the same for other drawings describing the XYZ axes. The expressions related to these directions are used for convenience of explanation, and are not intended to limit a posture of the structure in actual use.

As shown in FIG. 1 or FIG. 2, the vehicle 1 includes a vehicle body 2, wheels 3, an electric motor 4, and a battery pack 10. The vehicle 1 may be, for example, a battery electric vehicle (BEV), a plug-in hybrid vehicle (PHEV), or a hybrid vehicle (HEV).

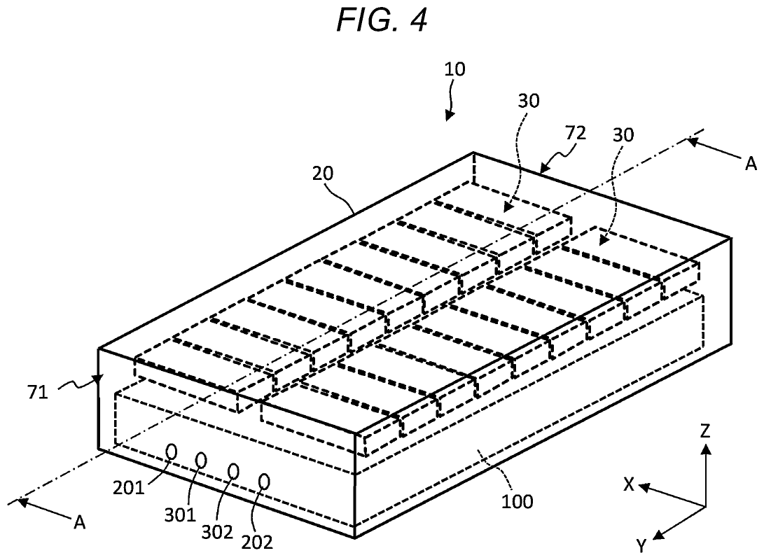

The battery pack 10 is accommodated in the vehicle body 2. The battery pack 10 includes one or more secondary batteries 30 (see FIG. 4) capable of being charged and discharged. An example of the secondary battery 30 is a lithium ion battery. The secondary battery 30 to be described below may be one or more. The secondary battery 30 supplies (discharges) stored electric power to the electric motor 4 or the like. The secondary battery 30 may store (charge) electric power generated by the electric motor 4 by regenerative energy. As shown in FIG. 1, the battery pack 10 may be accommodated under a floor of a center of the vehicle body 2. The battery pack 10 will be described in detail later.

The wheels 3 are coupled to the vehicle body 2. Although FIGS. 1 and 2 show an automobile in which the vehicle 1 includes four wheels 3, the vehicle 1 may include at least one wheel 3. For example, the vehicle 1 may be a motorcycle including two wheels 3 or a vehicle including three or five or more wheels 3. Further, one of the plurality of wheels 3 provided in the vehicle 1 may be referred to as a first wheel 3a, and one of the plurality of wheels 3, which is different from the first wheel 3a, may be referred to as a second wheel 3b. The first wheel 3a may be a front wheel of the vehicle 1, and the second wheel 3b may be a rear wheel of the vehicle 1. The vehicle 1 is movable in a predetermined direction (for example, a front-rear direction) by the first wheel 3a and the second wheel 3b.

The electric motor 4 drives at least one wheel 3 (for example, the first wheel 3a) using the electric power supplied from the secondary battery 30. The vehicle 1 includes at least one electric motor 4. The vehicle 1 may have a configuration in which the electric motor 4 drives the front wheel (that is, a front wheel drive configuration). Alternatively, the vehicle 1 may have a configuration in which the electric motor 4 drives the rear wheel (that is, a rear wheel drive configuration) or a configuration in which the electric motor 4 drives both the front wheel and the rear wheel (that is, a four wheel drive configuration). Alternatively, the vehicle 1 may include a plurality of electric motors 4, and each of the plurality of electric motors 4 may individually drive the wheel 3. The electric motor 4 may be installed in a motor room (engine room) located in front of the vehicle 1.

### Configuration of Electric Circuit

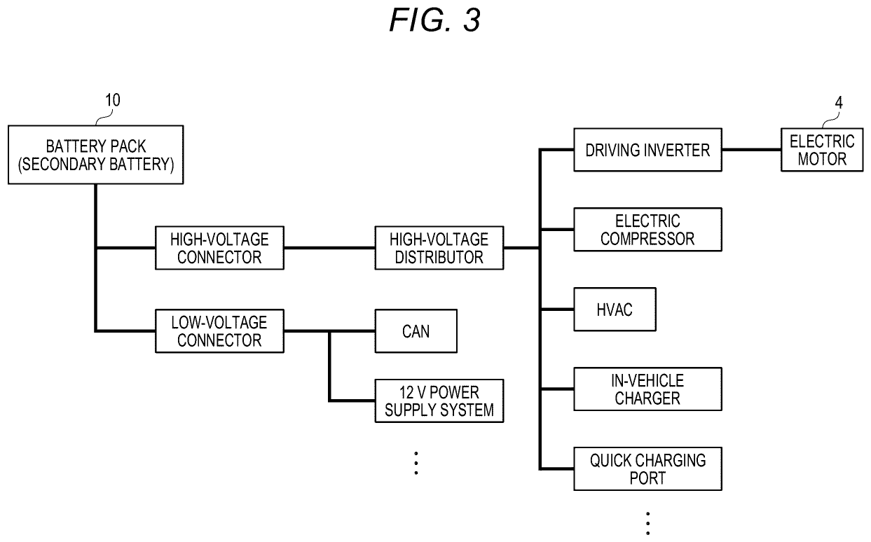

FIG. 3 is a diagram showing an example of an electric circuit provided in the vehicle 1 according to the embodiment of the present disclosure.

The battery pack 10 including the secondary battery 30 includes a high-voltage connector and a low-voltage connector. In the present disclosure, the high-voltage connector and the low-voltage connector are referred to as electrical connectors without being distinguished from each other.

A high-voltage distributor may be connected to the high-voltage connector. A driving inverter, an electric compressor, a heating, ventilation, and air conditioning (HVAC), an in-vehicle charger, and a quick charging port may be connected to the high-voltage distributor. A controller area network (CAN) and a 12 V power supply system may be connected to the low-voltage connector.

The electric motor 4 may be connected to the driving inverter. That is, the electric power output from the secondary battery 30 may be supplied to the electric motor 4 through the high-voltage connector, the high-voltage distributor, and the driving inverter.

### Configuration of Battery Pack

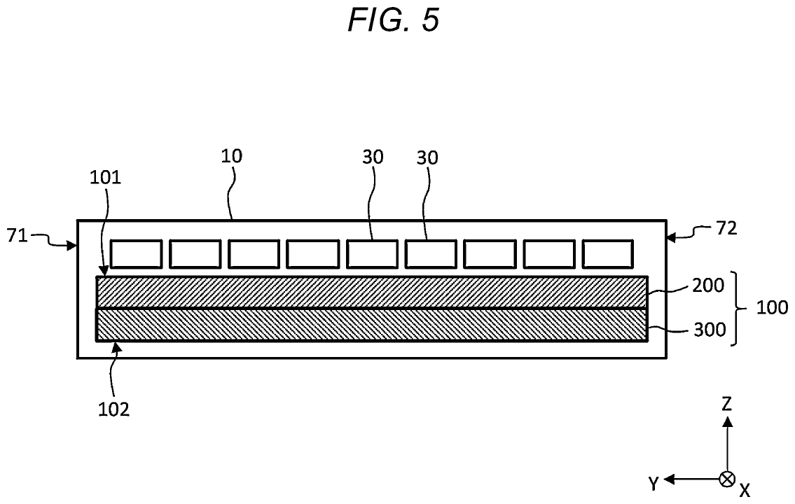

FIG. 4 is a perspective view showing a configuration example of the battery pack 10 according to the embodiment of the present disclosure. FIG. 5 is a cross-sectional view taken along a line A-A of the battery pack 10 shown in FIG. 4.

The battery pack 10 includes a housing 20, the secondary battery 30, and a heat exchange plate 100. The housing 20 accommodates the secondary battery 30 and the heat exchange plate 100.

The heat exchange plate 100 has, for example, a flat and substantially rectangular parallelepiped shape. The heat exchange plate 100 may be replaced with a heat exchanger. As shown in FIG. 5, the heat exchange plate 100 includes a first surface 101 disposed along a predetermined plane and a second surface 102 disposed along a predetermined plane. The predetermined plane may be a floor of the vehicle body 2. The members of the first surface 101 and the second surface 102 may be made of metal, for example, aluminum. However, the first surface 101 and the second surface 102 are not limited to metal and may be made of other materials.

The secondary battery 30 is disposed at a position opposite to the second surface 102 with reference to the first surface 101. That is, the second surface 102, the first surface 101, and the secondary battery 30 are arranged in this order from the floor of the vehicle body 2.

Between the first surface 101 and the second surface 102, the heat exchange plate 100 includes a coolant layer 200 that allows a coolant to circulate, and a refrigerant layer 300 that allows a refrigerant to circulate. The heat exchange plate 100 performs heat exchange between at least the secondary battery 30 and the coolant that moves in the coolant layer 200 via the first surface 101. Further, the heat exchange plate 100 performs heat exchange between at least the coolant that moves in the coolant layer 200 and the refrigerant that moves in the refrigerant layer 300. Examples of the coolant include an antifreezing solution including ethylene glycol. An example of the refrigerant is a hydrofluorocarbon (HFC). That is, the heat exchange plate 100 is a hybrid type heat exchange plate that uses the refrigerant and the coolant, thereby enabling the secondary battery 30 to be cooled overall by using the refrigerant to dissipate heat and using the coolant to equalize a temperature.

In the present embodiment, the heat exchange plate 100 is configured such that the coolant layer 200 is disposed on the refrigerant layer 300. However, the heat exchange plate 100 may be configured such that the refrigerant layer 300 is disposed on the coolant layer 200. The coolant layer 200 may be replaced with a coolant plate. The refrigerant layer 300 may be replaced with a refrigerant plate.

In the present embodiment, in the heat exchange plate 100, an end portion in a predetermined direction (for example, a positive direction of the Y axis) is referred to as a first end portion 71, and an end portion in a direction opposite to the first end portion 71 (for example, a negative direction of the Y axis) is referred to as a second end portion 72. The first end portion 71 may be a traveling direction side of the vehicle 1, and the second end portion 72 may be a side opposite to the traveling direction of the vehicle 1.

As shown in FIG. 4, a refrigerant input portion 301, a refrigerant output portion 302, a first coolant input and output portion 201, and a second coolant input and output portion 202 are disposed on the first end portion 71 of the heat exchange plate 100.

The refrigerant input portion 301 is a portion through which the refrigerant enters the refrigerant layer 300 from an outside of the heat exchange plate 100, and the refrigerant output portion 302 is a portion through which the refrigerant flows from the refrigerant layer 300 to the outside of the heat exchange plate 100.

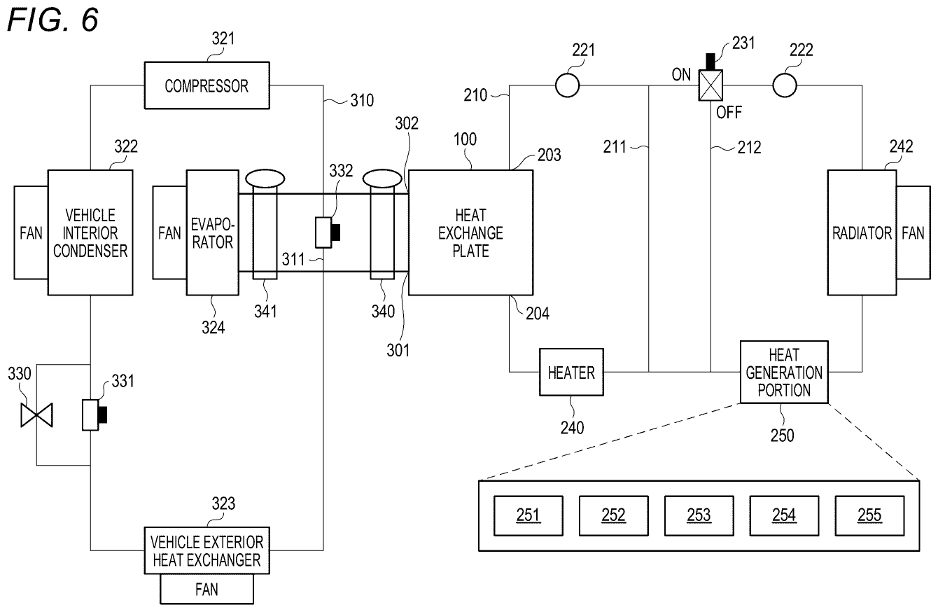

The first coolant input and output portion 201 is a portion through which the coolant enters the coolant layer 200 from the outside of the heat exchange plate 100, and the second coolant input and output portion 202 is a portion through which the coolant flows from the coolant layer 200 to the outside of the heat exchange plate 100. Alternatively, the second coolant input and output portion 202 may be a portion through which the coolant enters the coolant layer 200 from the outside of the heat exchange plate 100, and the first coolant input and output portion 201 may be a portion through which the coolant flows from the coolant layer 200 to the outside of the heat exchange plate 100. In the following description, the first coolant input and output portion 201 will be described as a coolant input portion 203 (see FIG. 6), and the second coolant input and output portion 202 will be described as a coolant output portion 204 (see FIG. 6). However, the second coolant input and output portion 202 may be the coolant input portion 203, and the first coolant input and output portion 201 may be the coolant output portion 204.

### First Embodiment

In the first embodiment, the vehicle 1 and a heat management system that can appropriately share the refrigerant between the hybrid type heat exchange plate 100 and a vehicle interior air conditioner will be described. Accordingly, the number of components constituting the vehicle 1 is created, manufacturing efficiency can be improved, and heat exchange efficiency can be improved. Further, a temperature of the secondary battery 30 can be appropriately adjusted to prevent deterioration, and heat pump heating can also be achieved. This will be described in detail below.

### First Configuration Example of Heat Management System

FIG. 6 is a diagram showing a first configuration example of the heat management system according to the first embodiment.

The heat management system according to the first embodiment includes a refrigerant circuit 310, a coolant circuit 210, and the heat exchange plate 100.

The refrigerant circuit 310 includes a compressor 321, a vehicle interior condenser 322 capable of exchanging heat with air in the vehicle interior of the vehicle 1, a vehicle exterior heat exchanger 323 capable of exchanging heat with air outside the vehicle, and the refrigerant input portion 301 and the refrigerant output portion 302 of the refrigerant layer 300 in the heat exchange plate 100. In the present embodiment, reducing a rotation speed of the compressor 321 to 0 or substantially 0 may be expressed as turning off the compressor 321, and increasing the rotation speed of the compressor 321 to a value greater than 0 may be expressed as turning on the compressor 321.

The refrigerant circuit 310 further includes a first on-off valve 331 disposed between the vehicle interior condenser 322 and the vehicle exterior heat exchanger 323, and an orifice valve 330 disposed across the first on-off valve 331. The first on-off valve 331 may be a solenoid valve.

The refrigerant circuit 310 further includes an evaporator 324 disposed between the

vehicle exterior heat exchanger 323 and the compressor 321, and a first EXV 341 that controls a flow rate of the refrigerant entering the evaporator 324 (or exiting from the evaporator 324). The first EXV 341 may be an electronic expansion valve. In the present embodiment, reducing the flow rate of refrigerant entering the evaporator 324 (or exiting from the evaporator 324) to 0 or substantially 0 may be referred to as closing the first EXV 341.

The refrigerant circuit 310 further includes a TXV 341 that controls a flow rate of the refrigerant entering the refrigerant input portion 301 (or exiting from the refrigerant output portion 302). The TXV 341 may be a mechanical expansion valve. In the present embodiment, reducing the flow rate of the refrigerant entering the refrigerant input portion 301 (or exiting from the refrigerant output portion 302) to 0 or substantially 0 may be referred to as closing the TXV 341.

The refrigerant circuit 310 further includes a bypass path 311 that connects the vehicle exterior heat exchanger 323 and the compressor 321 and bypasses the refrigerant layer 300 and the evaporator 324, and a second on-off valve 332 disposed in the bypass path 311. The second on-off valve 332 may be a solenoid valve.

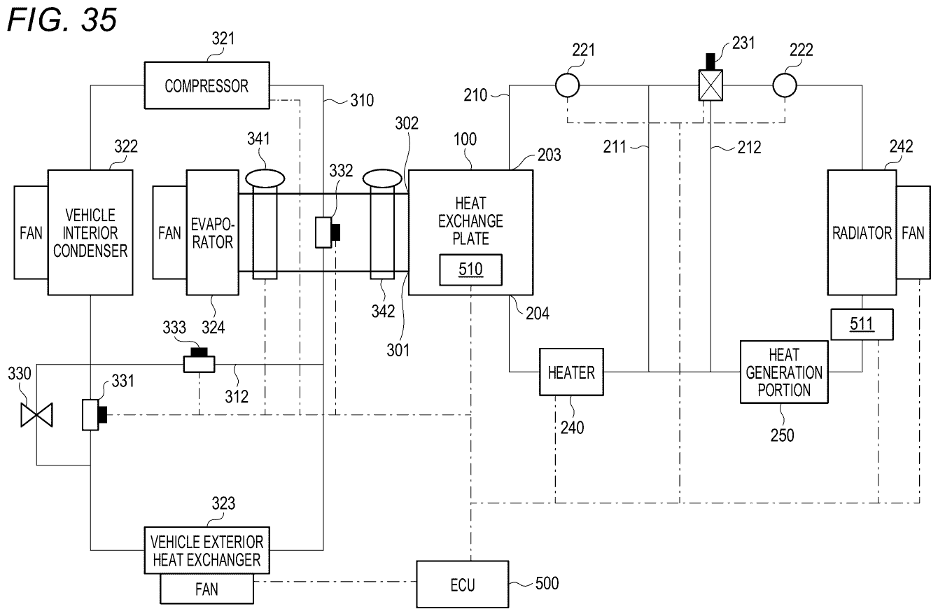

The coolant circuit 210 includes a first pump 221, the coolant input portion 203 and the coolant output portion 204 of the coolant layer 200 in the heat exchange plate 100, a heater 240, a heat generation portion 250, a radiator 242, a second pump 222, and a first three-way valve 231. The heat generation portion 250 is a device provided in the vehicle 1, which performs heat exchange with a device that generates heat during operation. The heat generation portion 250 may include, for example, at least one of an electric motor heat exchanger 251 that performs heat exchange with an electric motor, a charger heat exchanger 252 that performs heat exchange with a charger, an inverter heat exchanger 253 that exchanges heat with an inverter, a converter heat exchanger 254 that exchanges heat with a converter, and an ECU heat exchanger 255 that exchanges heat with a ECU 500 (see FIG. 35).

The charger controls charging of the secondary battery 30. The inverter converts a DC current of the secondary battery 30 into an AC current that is driven by the electric motor. The converter converts an AC current generated by the electric motor through regeneration into a DC current used for charging the secondary battery 30. The ECU 500 performs information processing related to the vehicle.

The coolant circuit 210 further includes a first branch coolant path 211 that connects a position between the first three-way valve 231 and the first pump 221 and a position between the heater 240 and the heat generation portion 250.

The coolant circuit 210 according to the first configuration example further includes a second branch coolant path 212 that connects the first three-way valve 231 with a position between the heater 240 and the heat generation portion 250 which is closer to the heat generation portion 250 than the first branch coolant path 211.

When the first three-way valve 231 is turned on, a path from the second pump 222 to the first pump 221 is opened and a path to the second branch coolant path 212 is closed. When the first three-way valve 231 is turned off, the path to the second branch coolant path 212 is opened, and the path from the second pump 222 to the first pump 221 is closed.

Next, an operation pattern of the heat management system according to the first configuration example shown in FIG. 6 will be described.

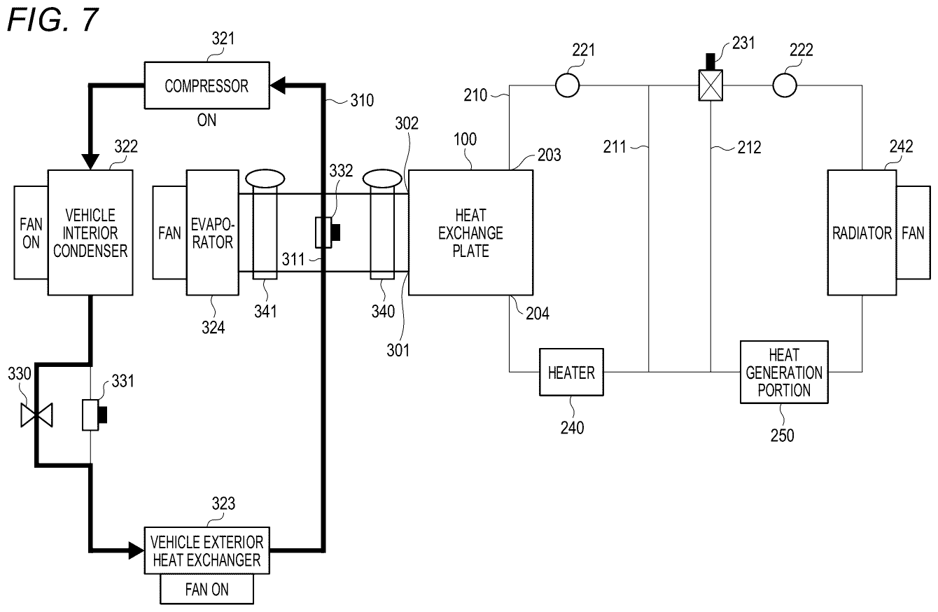

FIG. 7 is a diagram illustrating a first operation pattern of the heat management system when heating is performed in the vehicle interior according to the first configuration example.

In the refrigerant circuit 310, the compressor 321 is turned on, a fan of the vehicle interior condenser 322 is turned on, the first on-off valve 331 is closed, the orifice valve 330 is opened, a fan of the vehicle exterior heat exchanger 323 is turned on, the TXV 340 is closed, the first EXV 341 is closed, and the second on-off valve 332 is opened. In this case, as indicated by thick arrows on the refrigerant circuit 310 shown in FIG. 7, the refrigerant moves through the refrigerant circuit 310 as follows.

A high-temperature and high-pressure refrigerant that has exited from the compressor 321 being turned on enters the vehicle interior condenser 322 in a gas phase. The refrigerant that has entered the vehicle interior condenser 322 exchanges heat with the air in the vehicle interior in the vehicle interior condenser 322 in which the fan is turned on (for example, warms the air in the vehicle interior), and exits from the vehicle interior condenser 322 in a liquid phase, for example. The refrigerant that has exited from the vehicle interior condenser 322 does not pass through the closed first on-off valve 331 but passes through the opened orifice valve 330 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, absorbs heat from the air outside the vehicle) and exits from the vehicle exterior heat exchanger 323 in a gas phase, for example. The refrigerant that has exited from the vehicle exterior heat exchanger 323 does not pass through the closed TXV 340 and the closed first EXV 341, but passes through the bypass path 311 and the opened second on-off valve 332 and enters the compressor 321.

Accordingly, the refrigerant that moves in the refrigerant circuit 310 can warm the air in the vehicle interior in the vehicle interior condenser 322 by using heat obtained from the air outside the vehicle in the vehicle exterior heat exchanger 323 (that is, by using a heat pump mechanism).

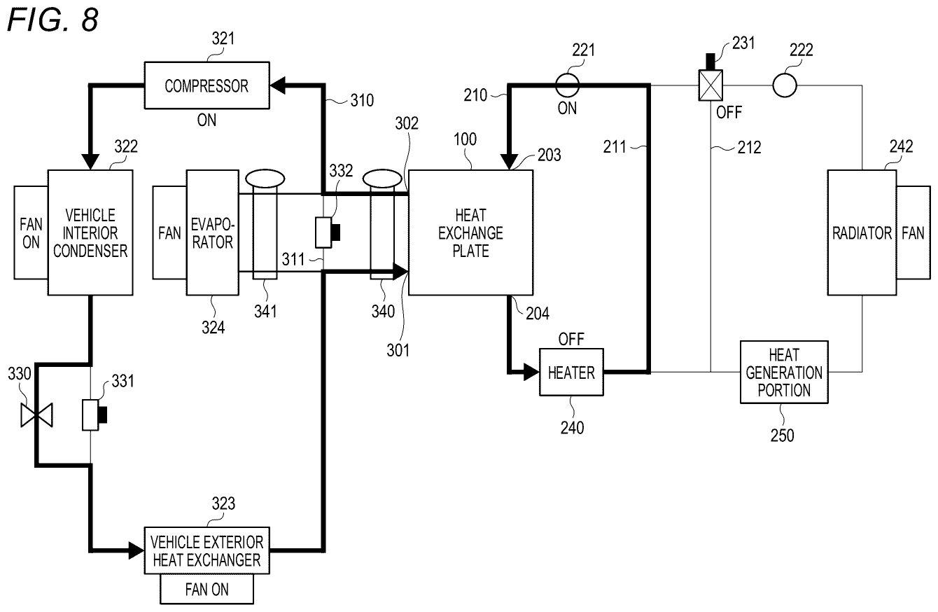

FIG. 8 is a diagram illustrating a second operation pattern of the heat management system when the heating is performed in the vehicle interior according to the first configuration example.

In the coolant circuit 210, the first pump 221 is turned on, the heater 240 is turned off, and the first three-way valve 231 is turned off. In this case, as indicated by thick arrows on the coolant circuit 210 shown in FIG. 8, the coolant circulates through the first pump 221, the coolant input portion 203, the coolant layer 200, the coolant output portion 204, the heater 240, and the first branch coolant path 211 in this order.

In the refrigerant circuit 310, the compressor 321 is turned on, the fan of the vehicle interior condenser 322 is turned on, the first on-off valve 331 is closed, the orifice valve 330 is opened, the fan of the vehicle exterior heat exchanger 323 is turned on, the TXV 340 is opened, the first EXV 341 is closed, and the second on-off valve 332 is closed. In this case, as indicated by thick arrows on the refrigerant circuit 310 shown in FIG. 8, the refrigerant moves through the refrigerant circuit 310 as follows.

The high-temperature and high-pressure refrigerant that has exited from the compressor 321 being turned on enters the vehicle interior condenser 322 in a gas phase. The refrigerant that has entered the vehicle interior condenser 322 exchanges heat with the air in the vehicle interior in the vehicle interior condenser 322 in which the fan is turned on (for example, warms the air in the vehicle interior), and exits from the vehicle interior condenser 322 in a liquid phase. The refrigerant that has exited from the vehicle interior condenser 322 does not pass through the closed first on-off valve 331 but passes through the opened orifice valve 330 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, absorbs heat from the air outside the vehicle) and exits from the vehicle exterior heat exchanger 323 in a gas-liquid two-phase, for example. The refrigerant that has exited from the vehicle exterior heat exchanger 323 does not pass through the closed first EXV 341 and the closed second on-off valve 332, but passes through the opened TXV 340 and the refrigerant input portion 301 and enters the refrigerant layer 300. The refrigerant that has entered the refrigerant layer 300 exchanges heat with the secondary battery 30 and the coolant of the coolant layer 200 (for example, is warmed by waste heat of the secondary battery 30), and exits from the refrigerant output portion 302 in a gas phase, for example. The refrigerant that has exited from the refrigerant output portion 302 enters the compressor 321.

Accordingly, the refrigerant can warm the air in the vehicle interior in the vehicle interior condenser 322 by using the heat obtained from the air outside the vehicle in the vehicle exterior heat exchanger 323 and heat obtained from waste heat of the secondary battery 30 in the refrigerant layer 300.

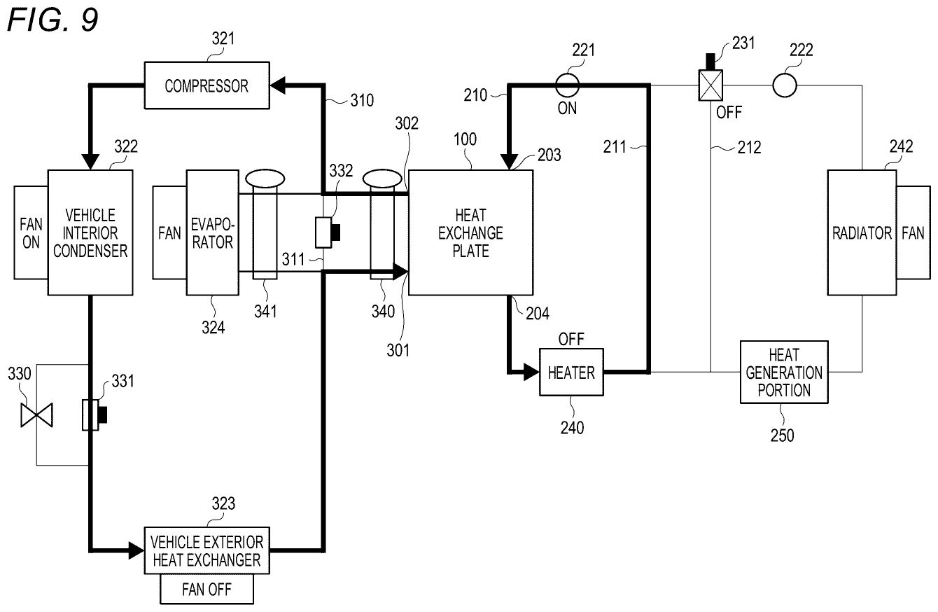

FIG. 9 is a diagram illustrating a third operation pattern of the heat management system when the heating is performed in the vehicle interior according to the first configuration example.

The coolant circuit 210 performs the same operation as in FIG. 8.

In the refrigerant circuit 310, the compressor 321 is turned on, the fan of the vehicle interior condenser 322 is turned on, the first on-off valve 331 is opened, the orifice valve 330 is closed, the fan of the vehicle exterior heat exchanger 323 is turned off, the TXV 340 is opened, the first EXV 341 is closed, and the second on-off valve 332 is closed. In this case, as indicated by thick arrows on the refrigerant circuit 310 shown in FIG. 9, the refrigerant moves through the refrigerant circuit 310 as follows.

The high-temperature and high-pressure refrigerant that has exited from the compressor 321 being turned on enters the vehicle interior condenser 322 in a gas phase, for example. The refrigerant that has entered the vehicle interior condenser 322 exchanges heat with the air in the vehicle interior in the vehicle interior condenser 322 in which the fan is turned on (for example, warms the air in the vehicle interior), and exits from the vehicle interior condenser 322 in a liquid phase. The refrigerant that has exited from the vehicle interior condenser 322 does not pass through the closed orifice valve 330, but passes through the opened first on-off valve 331 and enters the vehicle exterior heat exchanger 323. The refrigerant that has entered the vehicle exterior heat exchanger 323 hardly exchanges heat with the air outside the vehicle in the vehicle exterior heat exchanger 323 including a fan which is turned off, and exits from the vehicle exterior heat exchanger 323 in a liquid phase, for example. The refrigerant that has exited from the vehicle exterior heat exchanger 323 does not pass through the closed first EXV 341 and the closed second on-off valve 332, but passes through the opened TXV 340 and the refrigerant input portion 301 and enters the refrigerant layer 300. The refrigerant that has entered the refrigerant layer 300 exchanges heat with the secondary battery 30 and the coolant of the coolant layer 200, and enters the compressor 321 in a gas phase, for example.

Accordingly, the refrigerant can warm the air in the vehicle interior in the vehicle interior condenser 322 by using the heat obtained from the waste heat of the secondary battery 30 in the refrigerant layer 300.

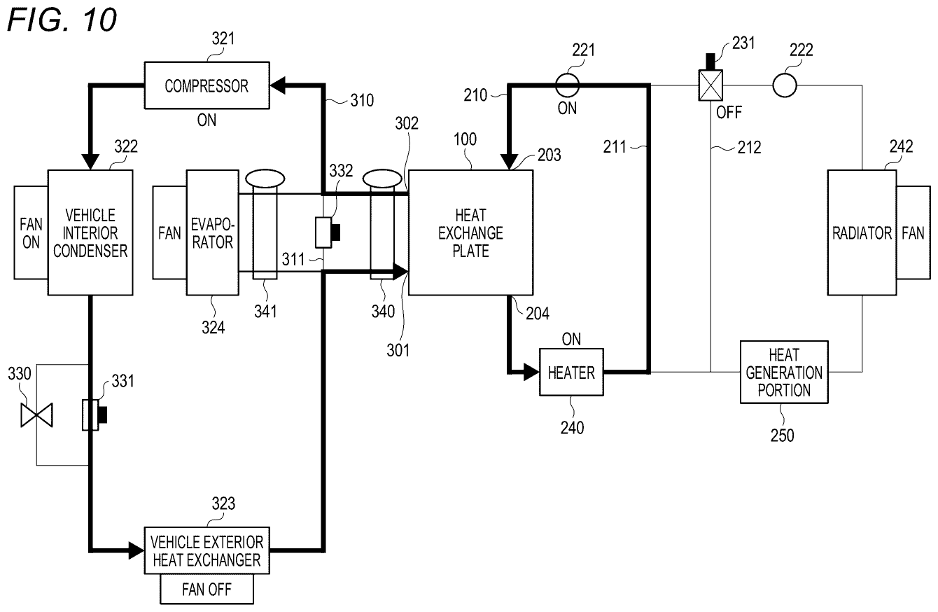

FIG. 10 is a diagram illustrating a fourth operation pattern of the heat management system when the heating is performed in the vehicle interior according to the first configuration example.

In the coolant circuit 210, the first pump 221 is turned on, the heater 240 is turned on, and a three-way valve is turned off. In this case, as indicated by thick arrows on the coolant circuit 210 shown in FIG. 10, the coolant circulates through the first pump 221, the coolant input portion 203, the coolant layer 200, the coolant output portion 204, the heater 240, and the first branch coolant path 211 in this order. The coolant is warmed by the heater 240 being turned on.

The refrigerant circuit 310 performs the same operation as in FIG. 9.

Accordingly, the refrigerant can warm the air in the vehicle interior in the vehicle interior condenser 322 by using the heat obtained from the waste heat of the secondary battery 30 and heat obtained from the coolant warmed by the heater 240 in the refrigerant layer 300.

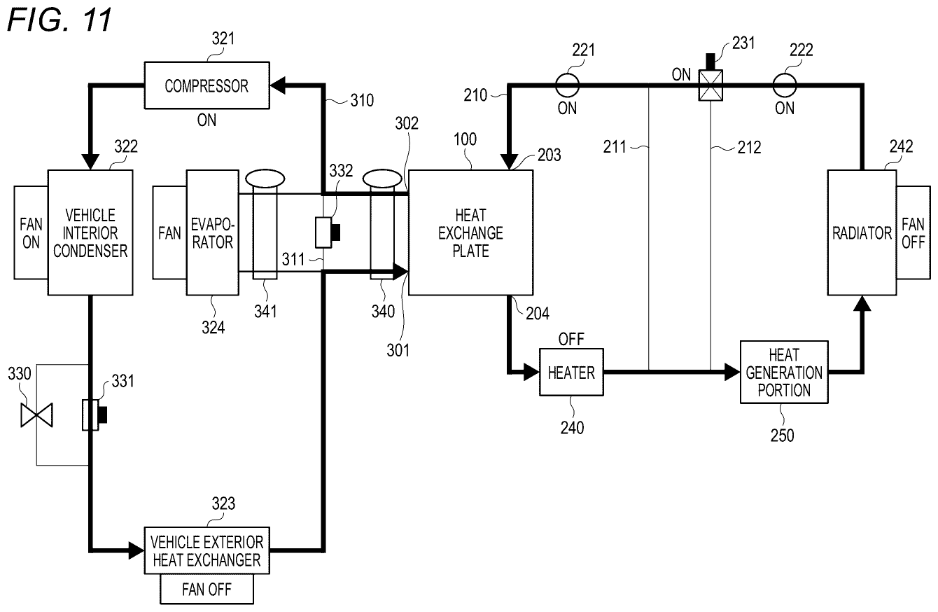

FIG. 11 is a diagram illustrating a fifth operation pattern of the heat management system when the heating is performed in the vehicle interior according to the first configuration example.

In the coolant circuit 210, the first pump 221 is turned on, the heater 240 is turned off, a fan of the radiator 242 is turned off, and the first three-way valve 231 is turned on. In this case, as indicated by thick arrows on the coolant circuit 210 illustrated in FIG. 11, the coolant circulates through the first pump 221, the coolant input portion 203, the coolant layer 200, the coolant output portion 204, the heater 240, the heat generation portion 250, the radiator 242, the second pump 222, and the first three-way valve 231 in this order. The coolant exchanges heat with the heat generation portion 250 (for example, is warmed by waste heat of the heat generation portion 250).

The refrigerant circuit 310 performs the same operation as in FIG. 9.

Accordingly, the refrigerant can warm the air in the vehicle interior in the vehicle interior condenser 322 by using the heat obtained from the waste heat of the secondary battery 30 and heat obtained from the coolant warmed by the waste heat of the heat generation portion 250 in the refrigerant layer 300.

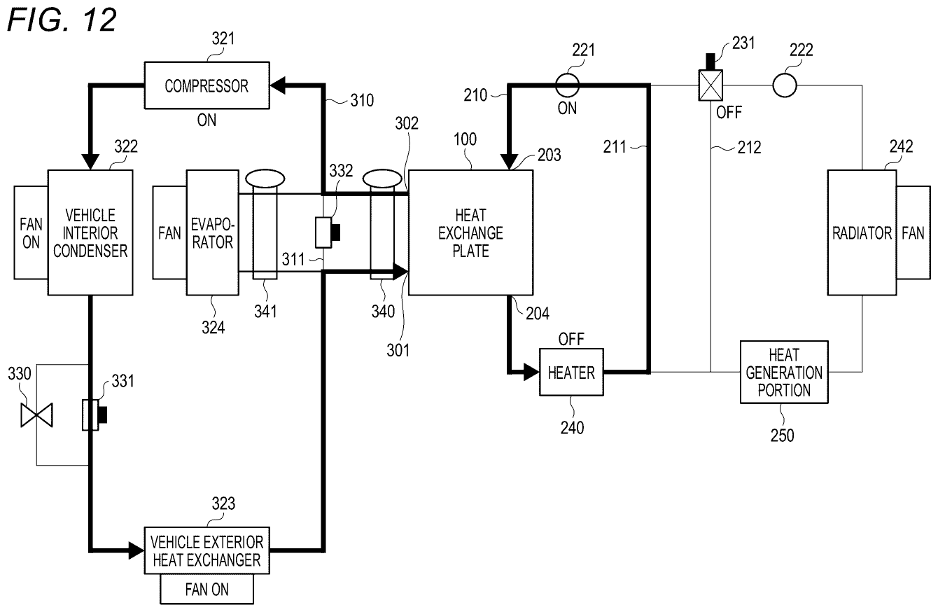

FIG. 12 is a diagram illustrating a sixth operation pattern of the heat management system when the heating is performed in the vehicle interior according to the first configuration example.

The coolant circuit 210 performs the same operation as in FIG. 8.

In the refrigerant circuit 310, the compressor 321 is turned on, the fan of the vehicle interior condenser 322 is turned on, the first on-off valve 331 is opened, the orifice valve 330 is closed, the fan of the vehicle exterior heat exchanger 323 is turned on, the TXV 340 is opened, the first EXV 341 is closed, and the second on-off valve 332 is closed. In this case, as indicated by thick arrows on the refrigerant circuit 310 shown in FIG. 12, the refrigerant moves through the refrigerant circuit 310 as follows.

The high-temperature and high-pressure refrigerant that has exited from the

compressor 321 being turned on enters the vehicle interior condenser 322 in a gas phase, for example. The refrigerant that has entered the vehicle interior condenser 322 exchanges heat with the air in the vehicle interior in the vehicle interior condenser 322 in which the fan is turned on (for example, warms the air in the vehicle interior), and exits from the vehicle interior condenser 322 in a gas-liquid two-phase. The refrigerant that has exited from the vehicle interior condenser 322 does not pass through the closed orifice valve 330, but passes through the opened first on-off valve 331 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on, and exits from the vehicle exterior heat exchanger 323 in a liquid phase, for example. The refrigerant that has exited from the vehicle exterior heat exchanger 323 does not pass through the closed first EXV 341 and the closed second on-off valve 332, but passes through the opened TXV 340 and the refrigerant input portion 301 and enters the refrigerant layer 300. The refrigerant that has entered the refrigerant layer 300 exchanges heat with the secondary battery 30 and the coolant of the coolant layer 200 (for example, is warmed by the waste heat of the secondary battery 30), and exits from the refrigerant output portion 302 in a gas phase, for example. The refrigerant that has exited from the refrigerant output portion 302 enters the compressor 321.

Accordingly, since the refrigerant can dissipate heat to the outside of the vehicle in the vehicle exterior heat exchanger 323, the secondary battery 30 can be sufficiently cooled in the refrigerant layer 300.

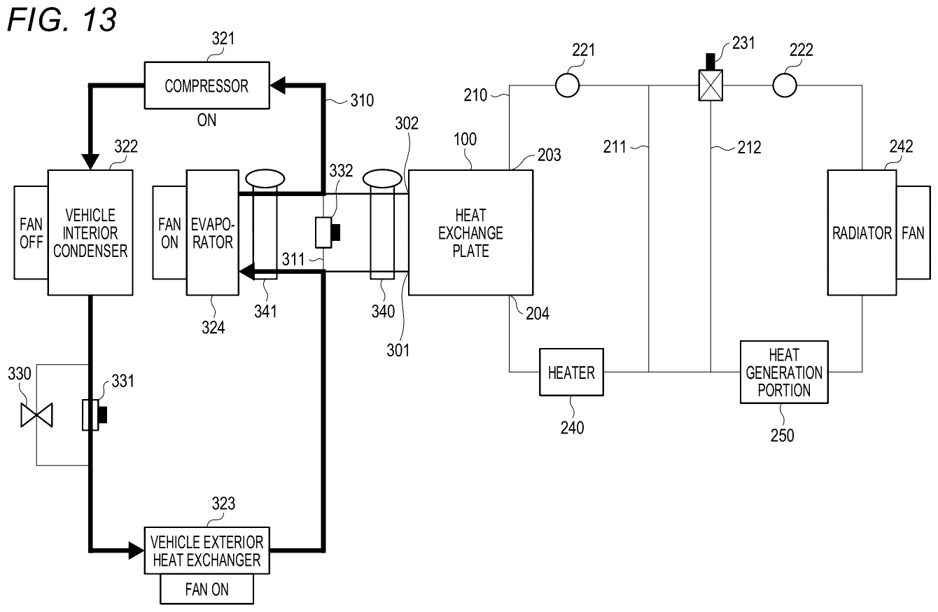

FIG. 13 is a diagram illustrating an operation pattern of the heat management system when cooling is performed in the vehicle interior according to the first configuration example.

In the refrigerant circuit 310, the compressor 321 is turned on, the fan of the vehicle interior condenser 322 is turned off, the first on-off valve 331 is opened, the orifice valve 330 is closed, the fan of the vehicle exterior heat exchanger 323 is turned on, the TXV 340 is closed, the first EXV 341 is opened, and the second on-off valve 332 is closed. In this case, as indicated by thick arrows on the refrigerant circuit 310 shown in FIG. 13, the refrigerant moves through the refrigerant circuit 310 as follows.

The high-temperature and high-pressure refrigerant that has exited from the compressor 321 being turned on enters the vehicle interior condenser 322 in a gas phase, for example. The refrigerant that has entered the vehicle interior condenser 322 hardly exchanges heat with the air in the vehicle interior in the vehicle interior condenser 322 in which the fan is turned off, and exits from the vehicle interior condenser 322. The refrigerant that has exited from the vehicle interior condenser 322 does not pass through the closed first on-off valve 331 but passes through the opened orifice valve 330 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, discharges heat to the air outside the vehicle) and exits from the vehicle exterior heat exchanger 323 in a liquid phase, for example. The refrigerant that has exited from the vehicle exterior heat exchanger 323 does not pass through the closed TXV 340 and the closed second on-off valve 332, but passes through the opened first EXV 341 and enters the evaporator 324. The refrigerant that has entered the evaporator 324 exchanges heat with the air in the vehicle interior in the evaporator 324 in which the fan is turned on (for example, cools the air in the vehicle interior), and exits from the evaporator 324 in a gas phase, for example. The refrigerant that has exited from the evaporator 324 enters the compressor 321.

Accordingly, the refrigerant can cool the air in the vehicle interior in the evaporator 324 without being affected by the waste heat of the secondary battery 30.

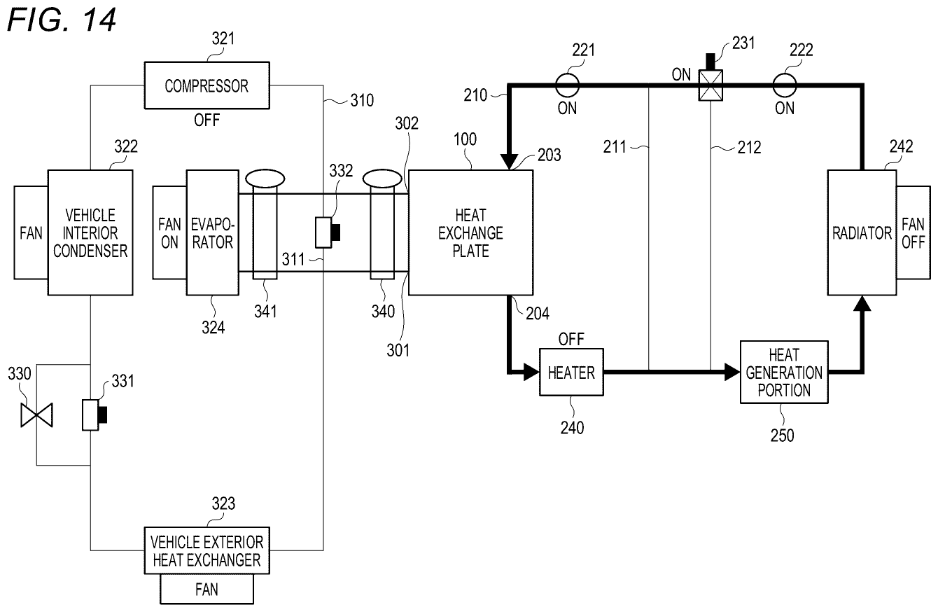

FIG. 14 is a diagram illustrating a first operation pattern of the heat management system when the secondary battery 30 is warmed according to the first configuration example.

In the coolant circuit 210, the first pump 221 is turned on, the heater 240 is turned off, the fan of the radiator 242 is turned off, the second pump 222 is turned on, and the first three-way valve 231 is turned on. In this case, as indicated by thick arrows on the coolant circuit 210 illustrated in FIG. 14, the coolant circulates through the first pump 221, the coolant input portion 203, the coolant layer 200, the coolant output portion 204, the heater 240, the heat generation portion 250, the radiator 242, the second pump 222, and the first three-way valve 231 in this order. The coolant is warmed by heat exchange with the heat generation portion 250.

In the refrigerant circuit 310, the compressor 321 is turned off.

Accordingly, the coolant can warm the secondary battery 30 in the coolant layer 200 by using heat obtained from the heat generation portion 250.

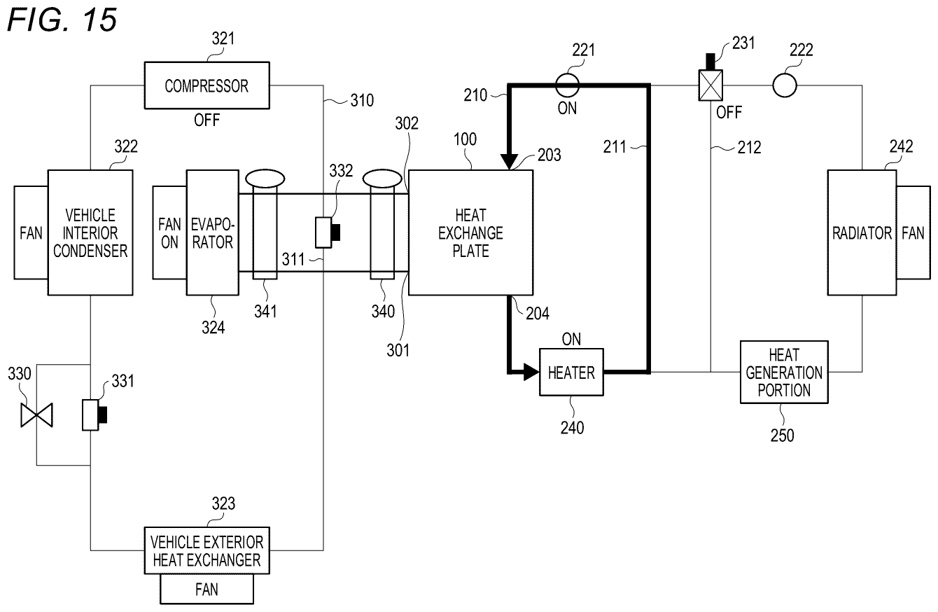

FIG. 15 is a diagram illustrating a second operation pattern of the heat management system when the secondary battery 30 is warmed according to the first configuration example.

In the coolant circuit 210, the first pump 221 is turned on, the heater 240 is turned on, and the first three-way valve 231 is turned off. In this case, as indicated by thick arrows on the coolant circuit 210 shown in FIG. 15, the coolant circulates through the first pump 221, the coolant input portion 203, the coolant layer 200, the coolant output portion 204, the heater 240, and the first branch coolant path 211 in this order. The coolant is warmed by the heater 240 being turned on.

In the refrigerant circuit 310, the compressor 321 is turned off.

Accordingly, the coolant can warm the secondary battery 30 in the coolant layer 200 by using the heat obtained from the heater 240 being turned on.

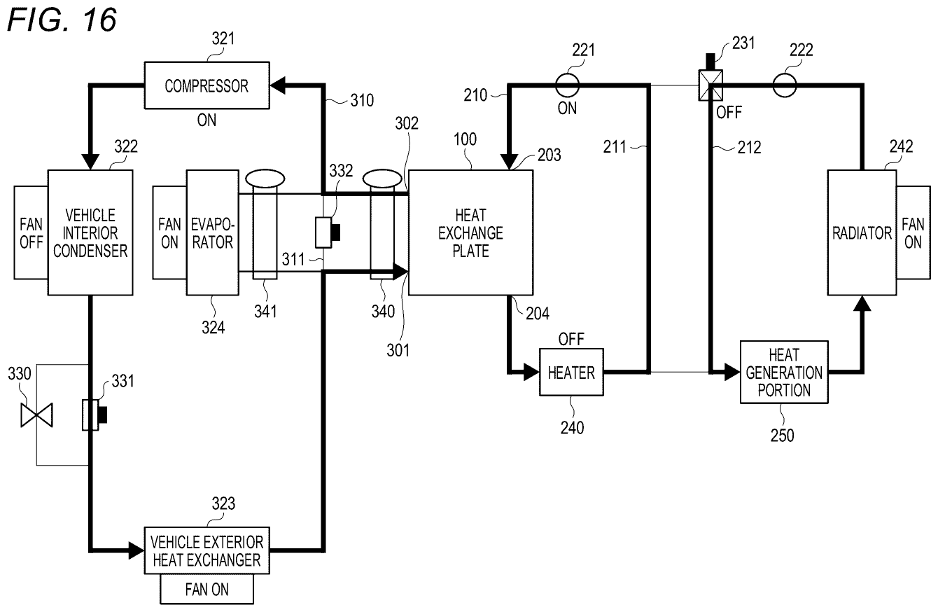

FIG. 16 is a diagram illustrating an operation pattern of the heat management system when the secondary battery 30 is cooled according to the first configuration example.

In the coolant circuit 210, the first pump 221 is turned on, the heater 240 is turned off, the fan of the radiator 242 is turned on, the second pump 222 is turned on, and the first three-way valve 231 is turned off. In this case, as indicated by thick arrows on the coolant circuit 210 shown in FIG. 16, the coolant passing through the coolant layer 200 circulates through the first pump 221, the coolant input portion 203, the coolant layer 200, the coolant output portion 204, the heater 240, and the first branch coolant path 211. On the other hand, as indicated by thick arrows on the coolant circuit 210 shown in FIG. 16, the coolant passing through the heat generation portion 250 circulates through the heat generation portion 250, the radiator 242 in which the fan is turned on, the second pump 222, the first three-way valve 231, and the second branch coolant path 212. The circulating coolant can cool the heat generation portion 250 by exchanging heat with the heat generation portion 250, and exchanging heat with the air outside the vehicle in the radiator 242 in which the fan is turned on.

In the refrigerant circuit 310, the compressor 321 is turned on, the fan of the vehicle interior condenser 322 is turned off, the first on-off valve 331 is opened, the orifice valve 330 is closed, the fan of the vehicle exterior heat exchanger 323 is turned on, the TXV 340 is opened, the first EXV 341 is closed, and the second on-off valve 332 is closed. In this case, as indicated by thick arrows on the refrigerant circuit 310 shown in FIG. 16, the refrigerant moves through the refrigerant circuit 310 as follows.

The high-temperature and high-pressure refrigerant that has exited from the compressor 321 being turned on enters the vehicle interior condenser 322 in a gas phase, for example. The refrigerant that has entered the vehicle interior condenser 322 hardly exchanges heat with the air in the vehicle interior in the vehicle interior condenser 322 in which the fan is turned off, and exits from the vehicle interior condenser 322. The refrigerant that has exited from the vehicle interior condenser 322 does not pass through the closed orifice valve 330, but passes through the opened first on-off valve 331 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, discharges heat to the air outside the vehicle) and exits from the vehicle exterior heat exchanger 323 in a liquid phase, for example. The refrigerant that has exited from the vehicle exterior heat exchanger 323 does not pass through the closed first EXV 341 and the closed second on-off valve 332, but passes through the opened TXV 340 and the refrigerant input portion 301 and enters the refrigerant layer 300.

The refrigerant that has entered the refrigerant layer 300 exchanges heat with the secondary battery 30 and the coolant in the coolant layer 200, and exits from the refrigerant output portion 302 in a gas phase, for example. The refrigerant that has exited from the refrigerant output portion 302 enters the compressor 321.

Accordingly, the refrigerant can exchange heat with the coolant in the refrigerant layer 300 and cool the secondary battery 30.

### Second Configuration Example of Heat Management System

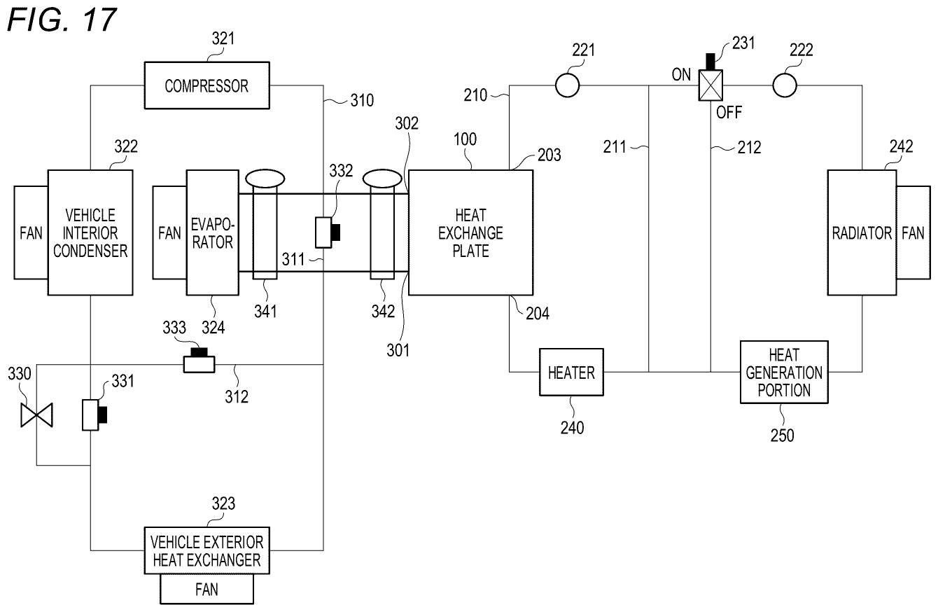

FIG. 17 is a diagram showing a second configuration example of the heat management system according to the first embodiment.

The refrigerant circuit 310 of the heat management system according to the second configuration example further includes a branch refrigerant path 312 and a third on-off valve 333 in the refrigerant circuit 310 shown in FIG. 6. The third on-off valve may be a solenoid valve. Further, the refrigerant circuit 310 according to the second configuration example replaces the TXV 340 in the refrigerant circuit 310 shown in FIG. 6 with an EXV. Hereinafter, the used EXV will be referred to as a second EXV 342. The second EXV 342 may be an electronic expansion valve.

The branch refrigerant path 312 connects a position between the vehicle interior condenser 322 and the first on-off valve 331 and a position between the vehicle exterior heat exchanger 323 and the second EXV 342 (or the first EXV 341). The third on-off valve 333 is disposed in the branch refrigerant path 312. The third on-off valve 333 may be a solenoid valve.

The coolant circuit 210 of the heat management system according to the second configuration example is the same as the coolant circuit 210 shown in FIG. 6.

Next, an operation pattern of the heat management system according to the second configuration example shown in FIG. 17 will be described.

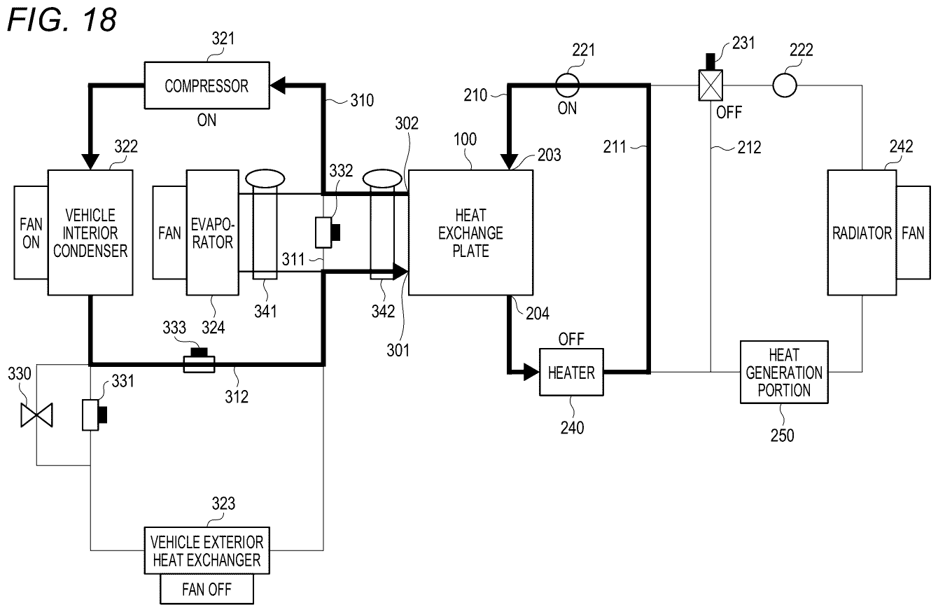

FIG. 18 is a diagram illustrating a first operation pattern of the heat management system when heating is performed in the vehicle interior according to the second configuration example.

In the coolant circuit 210, the first pump 221 is turned on, the heater 240 is turned off, and the three-way valve is turned off. In this case, as indicated by thick arrows on the coolant circuit 210 shown in FIG. 18, the coolant circulates through the first pump 221, the coolant input portion 203, the coolant layer 200, the coolant output portion 204, the heater 240, and the first branch coolant path 211 in this order.

In the refrigerant circuit 310, the compressor 321 is turned on, the fan of the vehicle interior condenser 322 is turned on, the first on-off valve 331 is closed, the orifice valve 330 is closed, the third on-off valve 333 is opened, the fan of the vehicle exterior heat exchanger 323 is turned off, the first EXV 341 is closed, the second EXV 342 is opened, and the second on-off valve 332 is closed. In this case, as indicated by thick arrows on the refrigerant circuit 310 shown in FIG. 18, the refrigerant moves through the refrigerant circuit 310 as follows.

The high-temperature and high-pressure refrigerant that has exited from the compressor 321 being turned on enters the vehicle interior condenser 322. The refrigerant that has entered the vehicle interior condenser 322 exchanges heat with the air in the vehicle interior in the vehicle interior condenser 322 in which the fan is turned on (for example, warms the air in the vehicle interior), and exits from the vehicle interior condenser 322. The refrigerant that has exited from the vehicle interior condenser 322 does not pass through the closed first on-off valve 331 and the closed orifice valve 330, but passes through the opened third on-off valve 333 and exits from the branch refrigerant path 312. The refrigerant that has exited from the branch refrigerant path 312 does not pass through the closed first EXV 341 and the closed second on-off valve 332, but passes through the opened second EXV 342 and the refrigerant input portion 301 and enters the refrigerant layer 300. The refrigerant that has entered the refrigerant layer 300 exchanges heat with the secondary battery 30 and the coolant of the coolant layer 200 (for example, is warmed by the waste heat of the secondary battery 30), and exits from the refrigerant output portion 302. The refrigerant that has exited from the refrigerant output portion 302 enters the compressor 321.

Accordingly, the refrigerant can warm the air in the vehicle interior in the vehicle interior condenser 322 by using the heat obtained from the waste heat of the secondary battery 30 in the refrigerant layer 300.

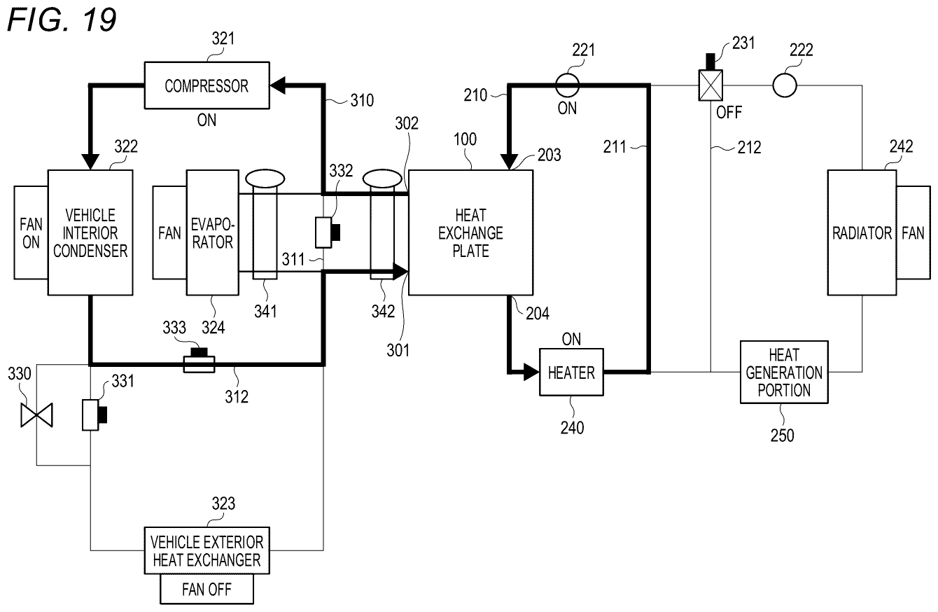

FIG. 19 is a diagram illustrating a second operation pattern of the heat management system when the heating is performed in the vehicle interior according to the second configuration example.

In the coolant circuit 210, the first pump 221 is turned on, the heater 240 is turned on, and the three-way valve is turned off. In this case, as indicated by thick arrows on the coolant circuit 210 shown in FIG. 19, the coolant circulates through the first pump 221, the coolant input portion 203, the coolant layer 200, the coolant output portion 204, the heater 240 which is turned on, and the first branch coolant path 211 in this order. The coolant is warmed by the heater 240 being turned on.

The refrigerant circuit 310 performs the same operation as in FIG. 18.

Accordingly, the refrigerant can warm the air in the vehicle interior in the vehicle interior condenser 322 by using the heat obtained from the coolant warmed by the heater 240 being turned on in the refrigerant layer 300.

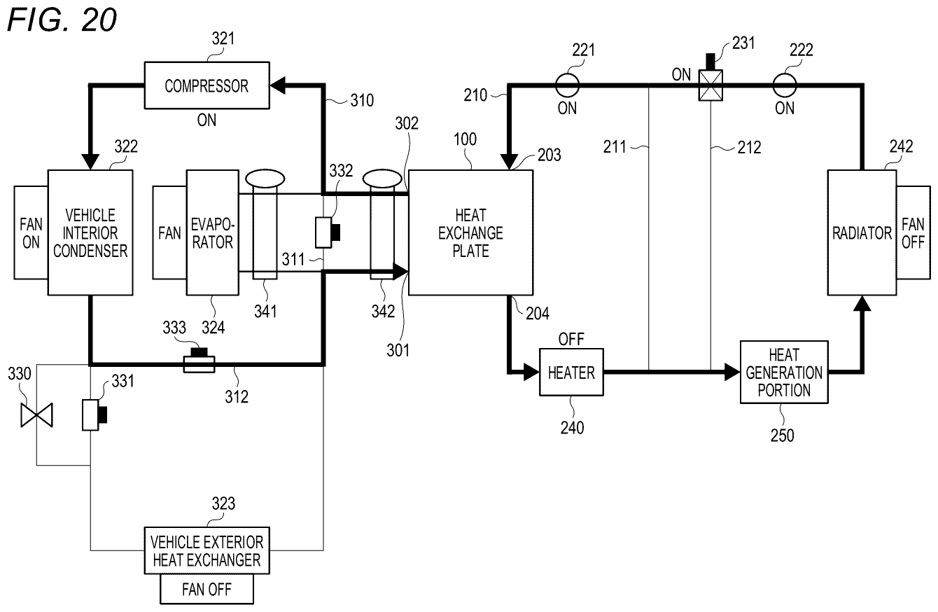

FIG. 20 is a diagram illustrating a third operation pattern of the heat management system when the heating is performed in the vehicle interior according to the second configuration example.

In the coolant circuit 210, the first pump 221 is turned on, the heater 240 is turned off, the fan of the radiator 242 is turned off, the second pump 222 is turned on, and the first three-way valve 231 is turned on. In this case, as indicated by thick arrows on the coolant circuit 210 illustrated in FIG. 20, the coolant circulates through the first pump 221, the coolant input portion 203, the coolant layer 200, the coolant output portion 204, the heater 240, the heat generation portion 250, the radiator 242, the second pump 222, and the first three-way valve 231 in this order. The coolant is warmed by heat exchange with the heat generation portion 250.

The refrigerant circuit 310 performs the same operation as in FIG. 18.

Accordingly, the refrigerant can warm the air in the vehicle interior in the vehicle interior condenser 322 by using the heat obtained from the waste heat of the secondary battery 30 in the refrigerant layer 300 and heat obtained from the coolant warmed by the heater 240 in the refrigerant layer 300.

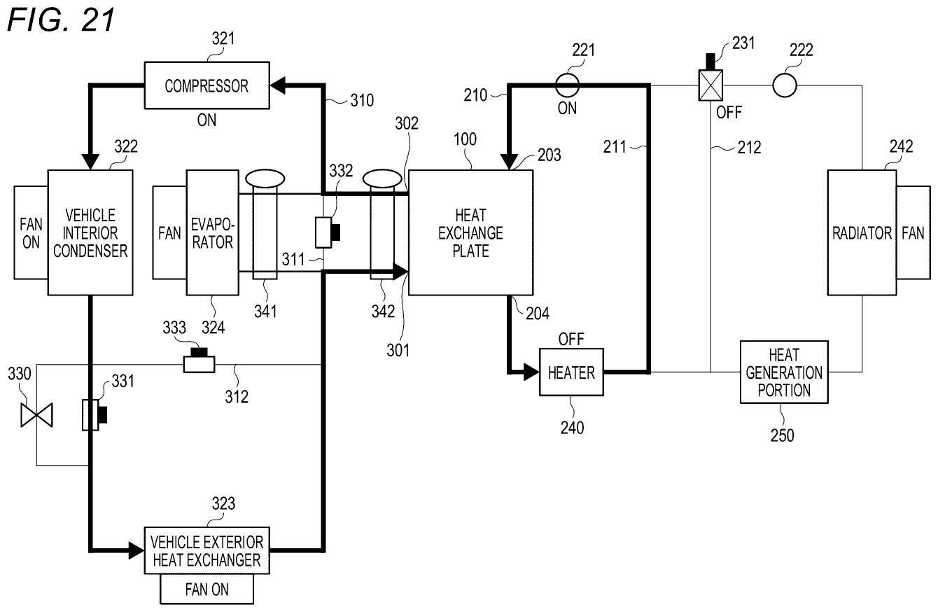

FIG. 21 is a diagram illustrating a fourth operation pattern of the heat management system when the heating is performed in the vehicle interior according to the second configuration example.

The coolant circuit 210 performs the same operation as in FIG. 18.

In the refrigerant circuit 310, the compressor 321 is turned on, the fan of the vehicle interior condenser 322 is turned on, the first on-off valve 331 is opened, the orifice valve 330 is closed, the third on-off valve 333 is closed, the fan of the vehicle exterior heat exchanger 323 is turned on, the first EXV 341 is closed, the second EXV 342 is opened, and the second on-off valve 332 is closed. In this case, as indicated by thick arrows on the refrigerant circuit 310 shown in FIG. 21, the refrigerant moves through the refrigerant circuit 310 as follows.

The high-temperature and high-pressure refrigerant that has exited from the compressor 321 being turned on enters the vehicle interior condenser 322. The refrigerant that has entered the vehicle interior condenser 322 exchanges heat with the air in the vehicle interior in the vehicle interior condenser 322 in which the fan is turned on (for example, warms the air in the vehicle interior), and exits from the vehicle interior condenser 322. The refrigerant that has exited from the vehicle interior condenser 322 does not pass through the closed orifice valve 330 and the closed third on-off valve 333, but passes through the opened first on-off valve 331 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, absorbs heat from the air outside the vehicle) and exits from the vehicle exterior heat exchanger 323. The refrigerant that has exited from the vehicle exterior heat exchanger 323 does not pass through the closed first EXV 341 and the closed second on-off valve 332, but passes through the opened second EXV 342 and the refrigerant input portion 301 and enters the refrigerant layer 300. The refrigerant that has entered the refrigerant layer 300 exchanges heat with the secondary battery 30 and the coolant (for example, is warmed by the waste heat of the secondary battery 30), and exits from the refrigerant output portion 302. The refrigerant that has exited from the refrigerant output portion 302 enters the compressor 321.

Accordingly, since the refrigerant can dissipate heat to the outside of the vehicle in the vehicle exterior heat exchanger 323, the secondary battery 30 can be sufficiently cooled in the refrigerant layer 300.

FIG. 22 is a diagram illustrating an operation pattern of the heat management system when the cooling is performed in the vehicle interior according to the second configuration example.

In the refrigerant circuit 310, the compressor 321 is turned on, the fan of the vehicle interior condenser 322 is turned off, the first on-off valve 331 is opened, the orifice valve 330 is closed, the third on-off valve 333 is closed, the fan of the vehicle exterior heat exchanger 323 is turned on, the first EXV 341 is opened, the second EXV 342 is closed, and the second on-off valve 332 is closed. In this case, as indicated by thick arrows on the refrigerant circuit 310 shown in FIG. 22, the refrigerant moves through the refrigerant circuit 310 as follows.

The high-temperature and high-pressure refrigerant that has exited from the compressor 321 being turned on enters the vehicle interior condenser 322. The refrigerant that has entered the vehicle interior condenser 322 hardly exchanges heat with the air in the vehicle interior in the vehicle interior condenser 322 in which the fan is turned off, and exits from the vehicle interior condenser 322. The refrigerant that has exited from the vehicle interior condenser 322 does not pass through the closed orifice valve 330 and the closed third on-off valve 333, but passes through the opened first on-off valve 331 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, discharges heat to the air outside the vehicle) and exits from the vehicle exterior heat exchanger 323. The refrigerant that has exited from the vehicle exterior heat exchanger 323 does not pass through the closed second EXV 342 and the closed second on-off valve 332, but passes through the opened first EXV 341 and enters the evaporator 324. The refrigerant that has entered the evaporator 324 exchanges heat with the air in the vehicle interior in the evaporator 324 in which the fan is turned on (for example, cools the air in the vehicle interior), and exits from the evaporator 324. The refrigerant that has exited from the evaporator 324 enters the compressor 321.

Accordingly, the refrigerant can cool the air in the vehicle interior in the evaporator 324 without being affected by the waste heat of the secondary battery 30.

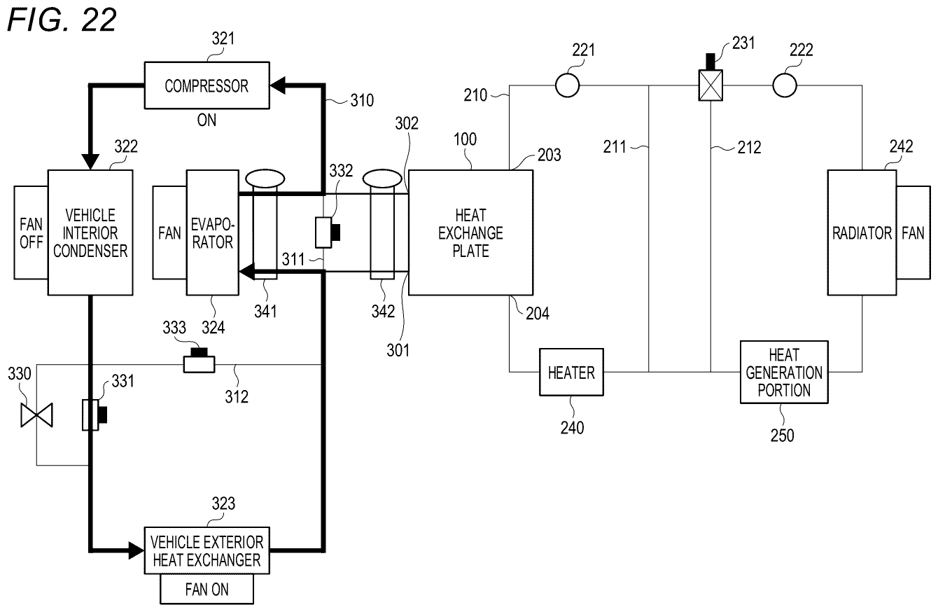

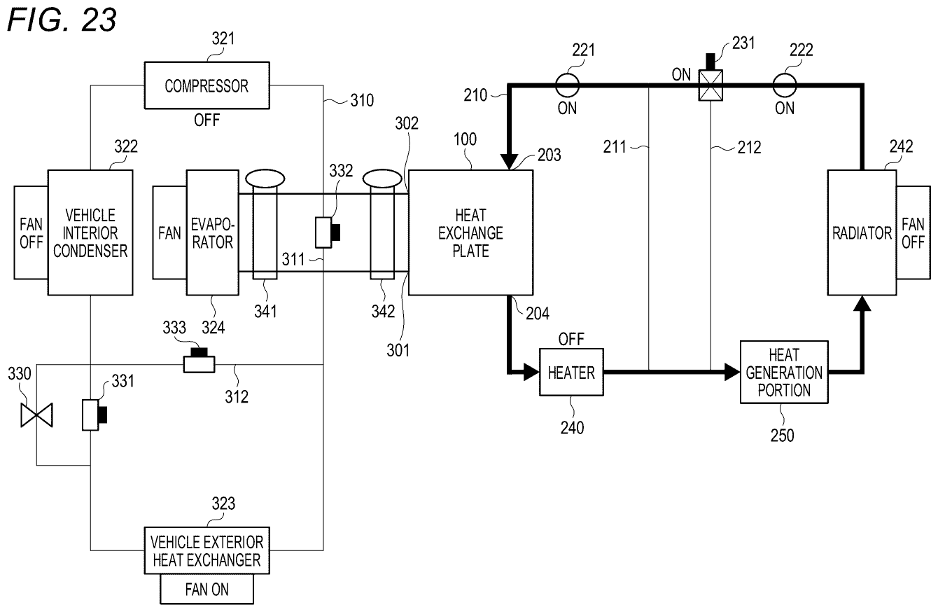

FIG. 23 is a diagram illustrating a first operation pattern of the heat management system when the secondary battery 30 is warmed according to the second configuration example.

In the coolant circuit 210, the first pump 221 is turned on, the heater 240 is turned off, the fan of the radiator 242 is turned off, the second pump 222 is turned on, and the first three-way valve 231 is turned on. In this case, as indicated by thick arrows on the coolant circuit 210 illustrated in FIG. 23, the coolant circulates through the first pump 221, the coolant input portion 203, the coolant layer 200, the coolant output portion 204, the heater 240, the heat generation portion 250, the radiator 242, the second pump 222, and the first three-way valve 231 in this order. The coolant is warmed by heat exchange with the heat generation portion 250.

In the refrigerant circuit 310, the compressor 321 is turned off.

Accordingly, the coolant can warm the secondary battery 30 in the coolant layer 200 by using heat obtained from the heat generation portion 250.

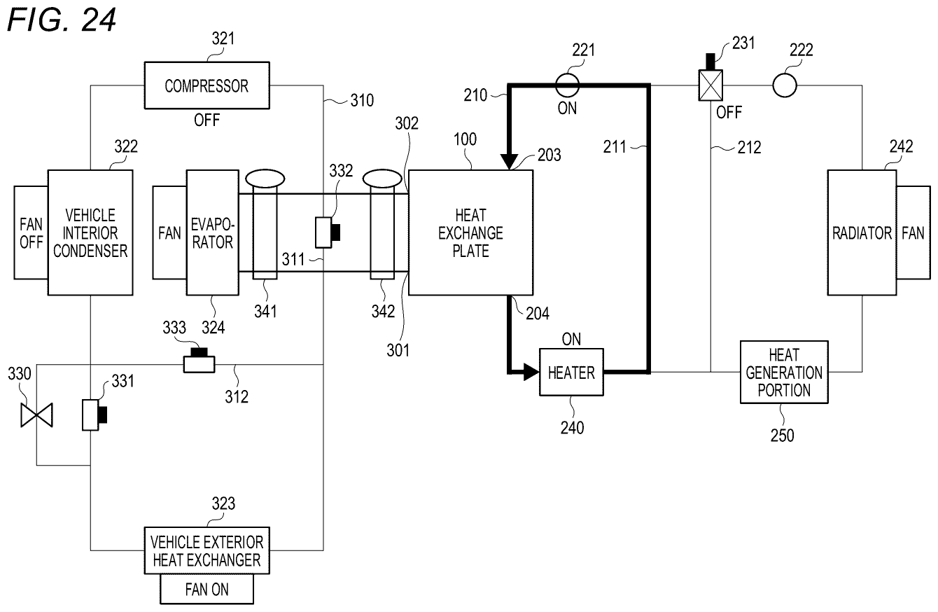

FIG. 24 is a diagram illustrating a second operation pattern of the heat management system when the secondary battery 30 is warmed according to the second configuration example.

In the coolant circuit 210, the first pump 221 is turned on, the heater 240 is turned on, and the first three-way valve 231 is turned off. In this case, as indicated by thick arrows on the coolant circuit 210 shown in FIG. 24, the coolant circulates through the first pump 221, the coolant input portion 203, the coolant layer 200, the coolant output portion 204, the heater 240, and the first branch coolant path 211 in this order. The coolant is warmed by the heater 240 being turned on.

In the refrigerant circuit 310, the compressor 321 is turned off.

Accordingly, the coolant can warm the secondary battery 30 in the coolant layer 200 by using the heat obtained from the heater 240 being turned on.

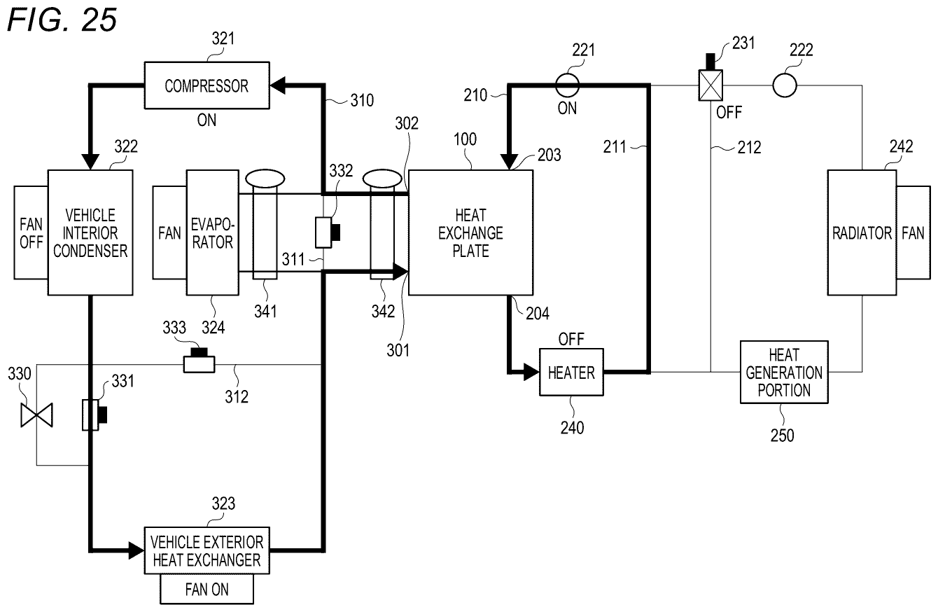

FIG. 25 is a diagram illustrating an operation pattern of the heat management system when the secondary battery 30 is cooled according to the second configuration example.

In the coolant circuit 210, the first pump 221 is turned on, the heater 240 is turned off, and the first three-way valve 231 is turned off. In this case, as indicated by thick arrows on the coolant circuit 210 shown in FIG. 25, the coolant circulates through the first pump 221, the coolant input portion 203, the coolant layer 200, the coolant output portion 204, the heater 240, and the first branch coolant path 211 in this order.

In the refrigerant circuit 310, the compressor 321 is turned on, the fan of the vehicle interior condenser 322 is turned off, the first on-off valve 331 is opened, the orifice valve 330 is closed, the third on-off valve 333 is closed, the fan of the vehicle exterior heat exchanger 323 is turned on, the first EXV 341 is closed, the second EXV 342 is opened, and the second on-off valve 332 is closed. In this case, as indicated by thick arrows on the refrigerant circuit 310 shown in FIG. 25, the refrigerant moves through the refrigerant circuit 310 as follows.

The high-temperature and high-pressure refrigerant that has exited from the compressor 321 being turned on enters the vehicle interior condenser 322. The refrigerant that has entered the vehicle interior condenser 322 hardly exchanges heat with the air in the vehicle interior in the vehicle interior condenser 322 in which the fan is turned off, and exits from the vehicle interior condenser 322. The refrigerant that has exited from the vehicle interior condenser 322 does not pass through the closed orifice valve 330 and the closed third on-off valve 333, but passes through the opened first on-off valve 331 and enters the vehicle exterior heat exchanger 323. The refrigerant that has entered the vehicle exterior heat exchanger 323 exchanges heat with the air outside the vehicle in the vehicle exterior heat exchanger 323 in which the fan is turned on (for example, discharges heat to the air outside the vehicle) and exits from the vehicle exterior heat exchanger 323. The refrigerant that has exited from the vehicle exterior heat exchanger 323 does not pass through the closed first EXV 341 and the closed second on-off valve 332, but passes through the opened second EXV 342 and the refrigerant input portion 301 and enters the refrigerant layer 300. The refrigerant that has entered the refrigerant layer 300 exchanges heat with the secondary battery 30 and the coolant, and exits from the refrigerant output portion 302. The refrigerant that has exited from the refrigerant output portion 302 enters the compressor 321.

Accordingly, the refrigerant can exchange heat with the coolant in the refrigerant layer 300 and cool the secondary battery 30.

### Third Configuration Example of Heat Management System

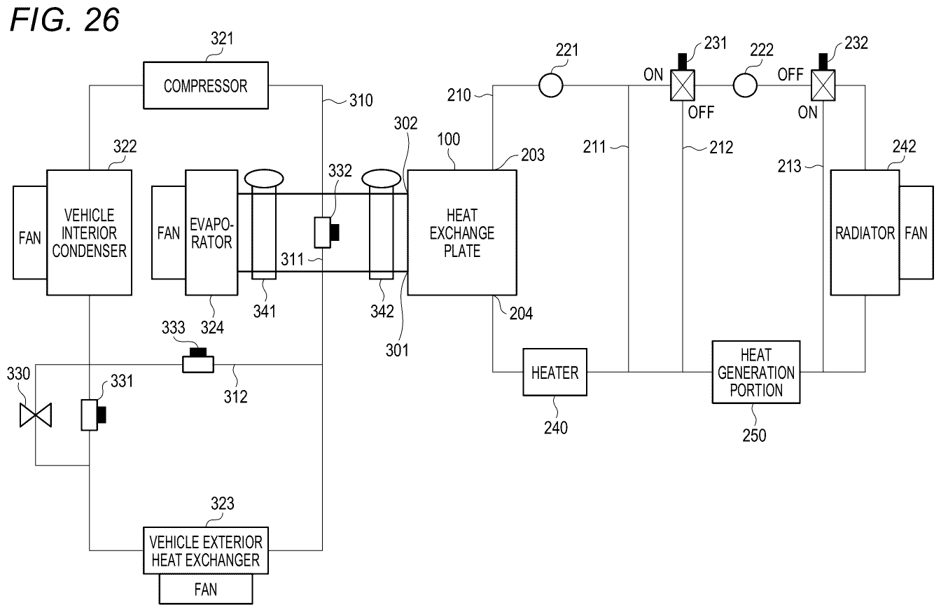

FIG. 26 is a diagram showing a third configuration example of the heat management system according to the first embodiment.

The coolant circuit 210 of the heat management system according to the third configuration example further includes a third branch coolant path 213 and a second three-way valve 232 in the coolant circuit 210 illustrated in FIG. 17.

The second three-way valve 232 is disposed between the second pump 222 and the radiator 242. The third branch coolant path 213 connects the second three-way valve 232 and a position between the heat generation portion 250 and the radiator 242. When the second three-way valve 232 is turned on, a path to the third branch coolant path 213 is opened and a path from the radiator 242 to the second pump 222 is closed. When the second three-way valve 232 is turned off, a path from the radiator 242 to the second pump 222 is opened and a path to the third branch coolant path 213 is closed.

The refrigerant circuit 310 of the heat management system according to the third configuration example is the same as the refrigerant circuit 310 illustrated in FIG. 17.

Next, an operation pattern of the heat management system according to the third configuration example shown in FIG. 26 will be described.

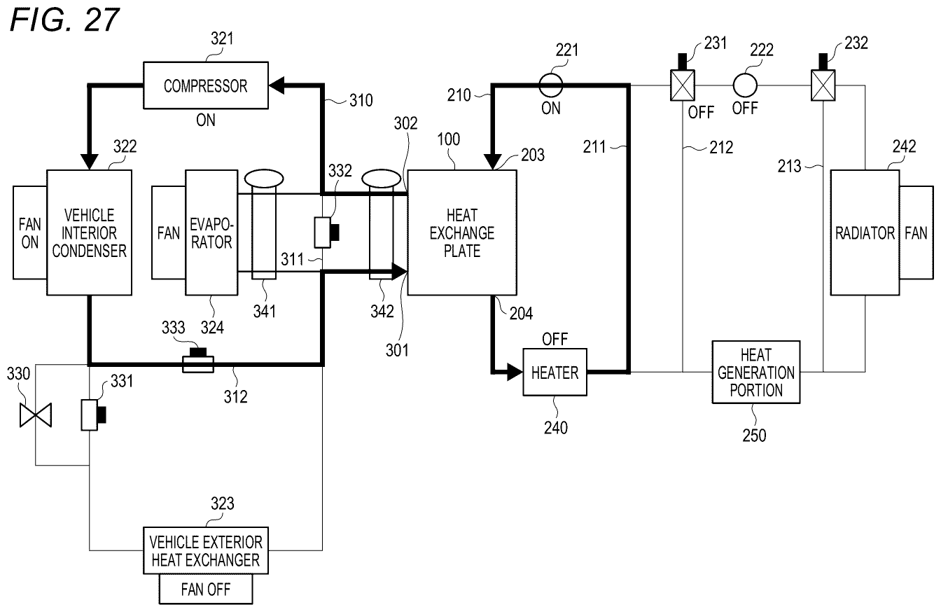

FIG. 27 is a diagram illustrating a first operation pattern of the heat management system when the heating is performed in the vehicle interior according to the third configuration example.

In the coolant circuit 210, the first pump 221 is turned on, the heater 240 is turned off, and the three-way valve is turned off. In this case, as indicated by thick arrows on the coolant circuit 210 shown in FIG. 27, the coolant circulates through the first pump 221, the coolant input portion 203, the coolant layer 200, the coolant output portion 204, the heater 240, and the first branch coolant path 211 in this order.

The refrigerant circuit 310 performs the same operation as in FIG. 18.

Accordingly, similarly to FIG. 18, the refrigerant can warm the air in the vehicle interior in the vehicle interior condenser 322 by using the heat obtained from the waste heat of the secondary battery 30 in the refrigerant layer 300.

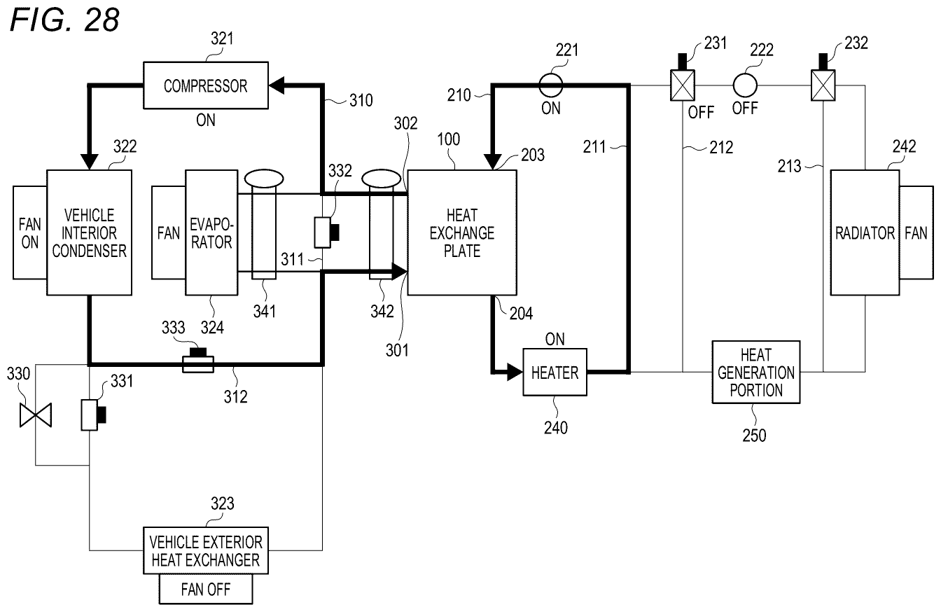

FIG. 28 is a diagram illustrating a second operation pattern of the heat management system when the heating is performed in the vehicle interior according to the third configuration example.

In the coolant circuit 210, the first pump 221 is turned on, the heater 240 is turned on, and the three-way valve is turned off. In this case, as indicated by thick arrows on the coolant circuit 210 shown in FIG. 28, the coolant circulates through the first pump 221, the coolant input portion 203, the coolant layer 200, the coolant output portion 204, the heater 240 which is turned on, and the first branch coolant path 211 in this order. The coolant is warmed by the heater 240 being turned on.

The refrigerant circuit 310 performs the same operation as in FIG. 18.

Accordingly, similarly to FIG. 19, the refrigerant can warm the air in the vehicle interior in the vehicle interior condenser 322 by using the heat obtained from the coolant warmed by the heater 240 being turned on in the refrigerant layer 300.

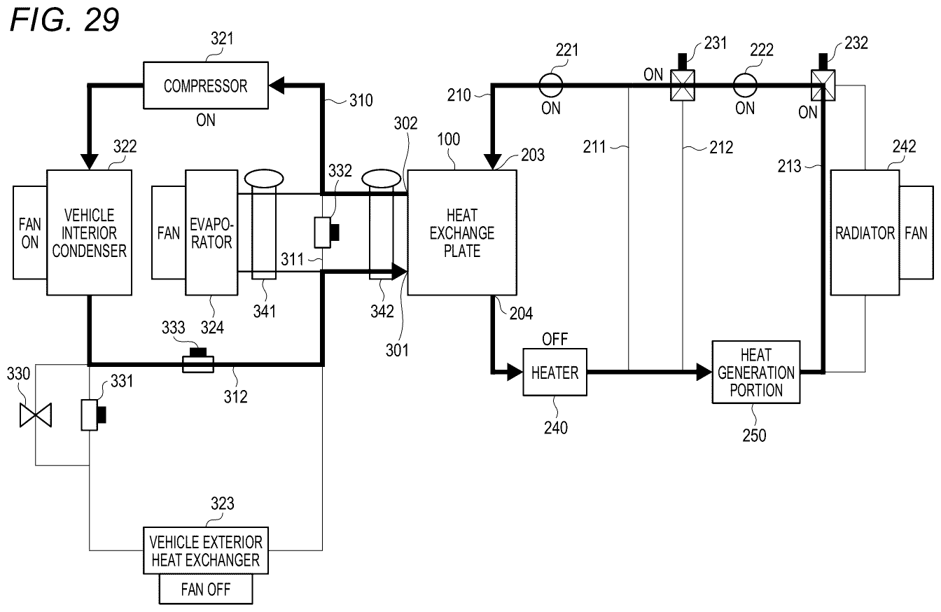

FIG. 29 is a diagram illustrating a third operation pattern of the heat management system when the heating is performed in the vehicle interior according to the third configuration example.

In the coolant circuit 210, the first pump 221 is turned on, the heater 240 is turned off, the first three-way valve 231 is turned on, the second three-way valve 232 is turned on, and the second pump 222 is turned on. In this case, as indicated by thick arrows on the coolant circuit 210 illustrated in FIG. 29, the coolant circulates through the first pump 221, the coolant input portion 203, the coolant layer 200, the coolant output portion 204, the heater 240, the heat generation portion 250, the third branch coolant path 213, the second three-way valve 232, the second pump 222, and the first three-way valve 231 in this order. The coolant is warmed by heat exchange with the heat generation portion 250.

The refrigerant circuit 310 performs the same operation as in FIG. 18.

Accordingly, the refrigerant can warm the air in the vehicle interior in the vehicle interior condenser 322 by using the heat obtained from the waste heat of the secondary battery 30 in the refrigerant layer 300 and heat obtained from the coolant warmed by the heat generation portion 250 in the refrigerant layer 300.

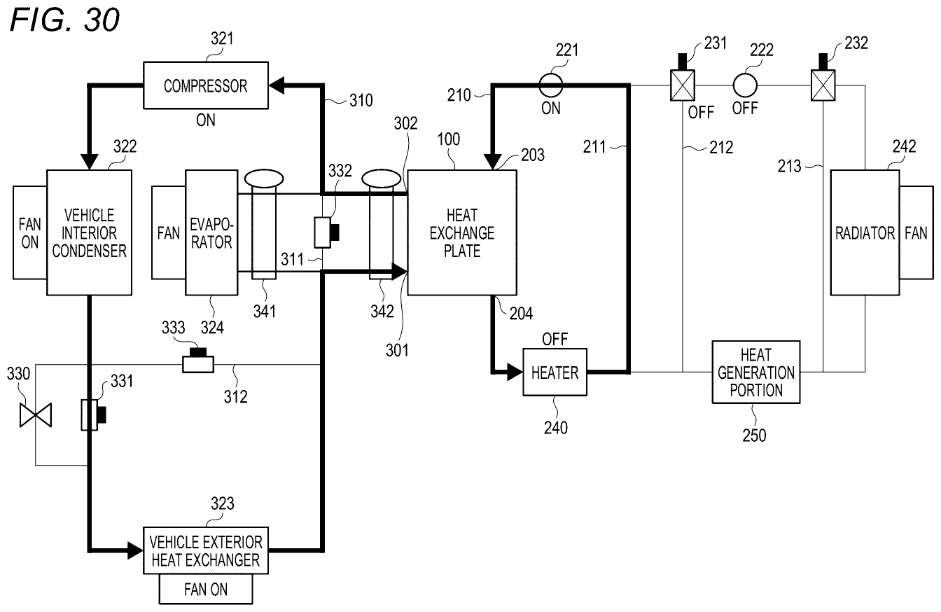

FIG. 30 is a diagram illustrating a fourth operation pattern of the heat management system when the heating is performed in the vehicle interior according to the third configuration example.

The coolant circuit 210 performs the same operation as in FIG. 27.

The refrigerant circuit 310 performs the same operation as in FIG. 21.

Accordingly, similarly to FIG. 21, since the refrigerant can dissipate heat to the outside of the vehicle in the vehicle exterior heat exchanger 323, the secondary battery 30 can be sufficiently cooled in the refrigerant layer 300.

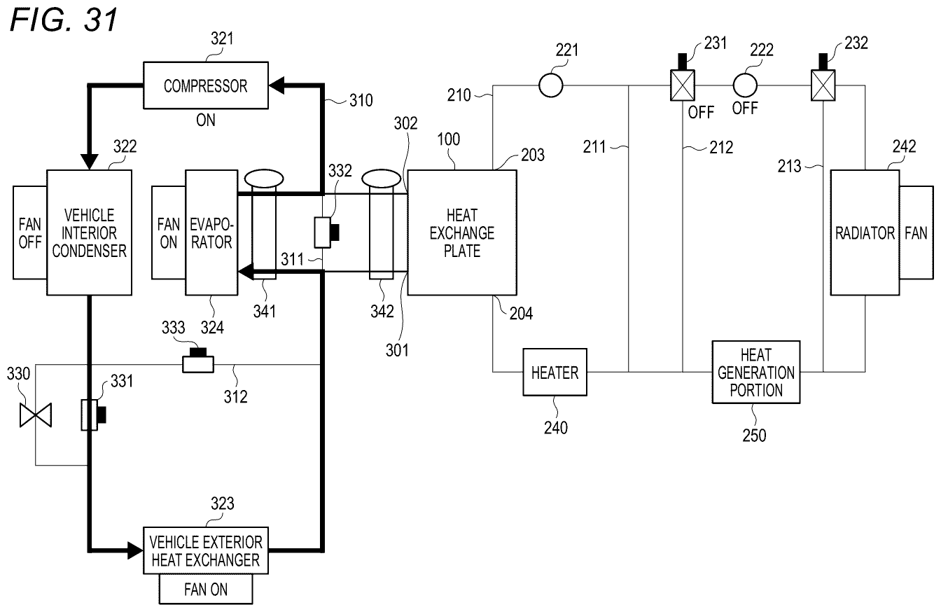

FIG. 31 is a diagram illustrating an operation pattern of the heat management system when the cooling is performed in the vehicle interior according to the third configuration example.

The refrigerant circuit 310 performs the same operation as in FIG. 22.

Accordingly, similarly to FIG. 22, the air in the vehicle interior can be cooled in the evaporator 324 without being affected by the waste heat of the secondary battery 30.

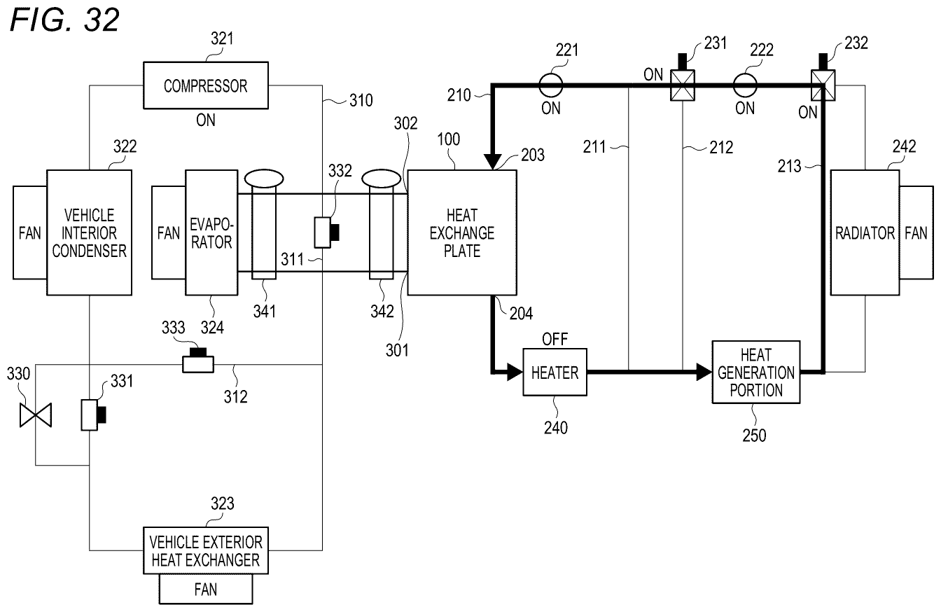

FIG. 32 is a diagram illustrating a first operation pattern of the heat management system when the secondary battery 30 is warmed according to the third configuration example.

In the coolant circuit 210, the first pump 221 is turned on, the heater 240 is turned off, the first three-way valve 231 is turned on, the second three-way valve 232 is turned on, and the second pump 222 is turned on. In this case, as indicated by thick arrows on the coolant circuit 210 illustrated in FIG. 32, the coolant circulates through the first pump 221, the coolant input portion 203, the coolant layer 200, the coolant output portion 204, the heater 240, the heat generation portion 250, the third branch coolant path 213, the second three-way valve 232, the second pump 222, and the first three-way valve 231 in this order. The coolant is warmed by heat exchange with the heat generation portion 250.

In the refrigerant circuit 310, the compressor 321 is turned off.

Accordingly, similarly to FIG. 23, the coolant can warm the secondary battery 30 in the coolant layer 200 by using heat obtained from the heat generation portion 250.

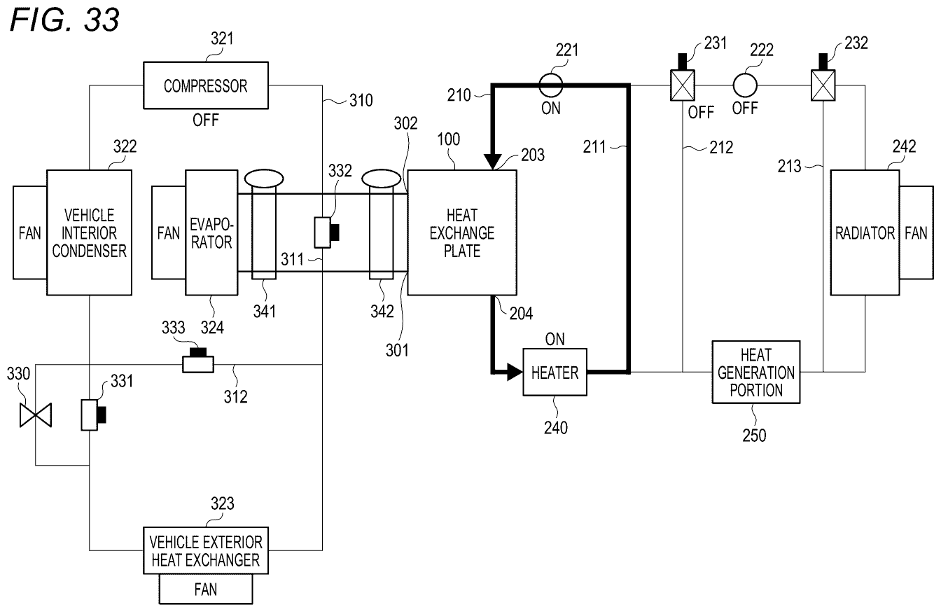

FIG. 33 is a diagram illustrating a second operation pattern of the heat management system when the secondary battery 30 is warmed according to the third configuration example.

In the coolant circuit 210, the first pump 221 is turned on, the heater 240 is turned on, and the first three-way valve 231 is turned off. In this case, as indicated by thick arrows on the coolant circuit 210 shown in FIG. 33, the coolant circulates through the first pump 221, the coolant input portion 203, the coolant layer 200, the coolant output portion 204, the heater 240, and the first branch coolant path 211 in this order. The coolant is warmed by the heater 240 being turned on.

In the refrigerant circuit 310, the compressor 321 is turned off.

Accordingly, similarly to FIG. 24, the coolant can warm the secondary battery 30 in the coolant layer 200 by using the heat obtained from the heater 240 being turned on.

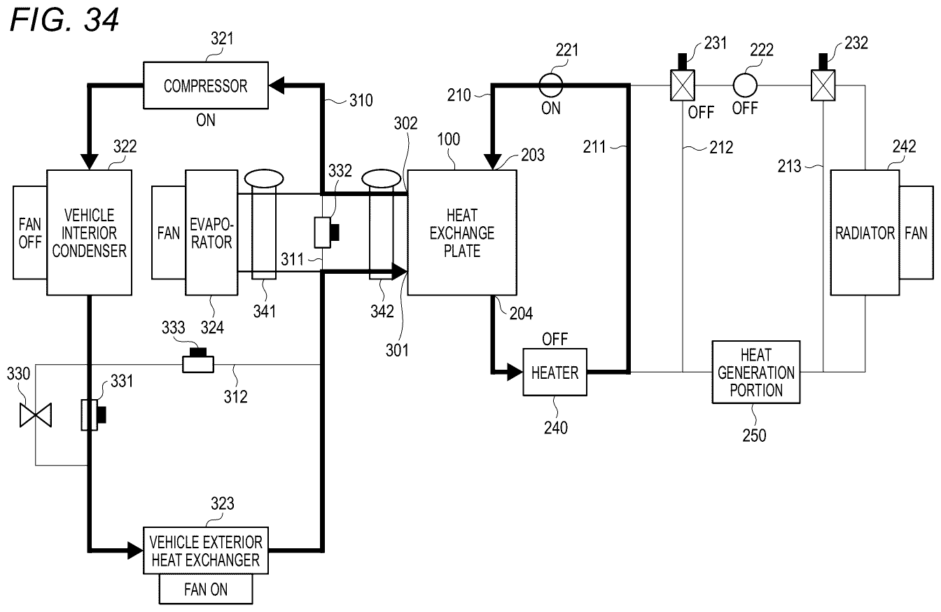

FIG. 34 is a diagram illustrating an operation pattern of the heat management system when the secondary battery 30 is cooled according to the third configuration example.

The coolant circuit 210 performs the same operation as in FIG. 25.

The refrigerant circuit 310 performs the same operation as in FIG. 25.

Accordingly, similarly to FIG. 25, the refrigerant can exchange heat with the coolant in the refrigerant layer 300 and cool the secondary battery 30.

### System Configuration

FIG. 35 is a diagram showing a configuration example including the ECU 500 and the like in the heat management system according to the second configuration example. The heat management systems according to the first configuration example and the third configuration example may also have a configuration including the ECU 500 and the like similarly to FIG. 35.

The heat management system may include the ECU 500 that performs processing of achieving the above-described operation pattern. The ECU 500 may be read as other terms such as a processor, a control unit, a CPU, a controller, or a calculation unit.

As shown in FIG. 35, for example, the ECU 500 can control on and off (control the number of rotations) of the compressor 321, opening and closing of the first on-off valve 331, opening and closing of the second on-off valve 332, opening and closing of the third on-off valve 333, and on and off of the fan of the vehicle exterior heat exchanger 323 via signal lines indicated by dashed lines in FIG. 35. The ECU 500 can control, via signal lines, on and off of the first pump 221, on and off of the second pump 222, on and off of the heater 240, on and off of the first three-way valve 231, and on and off of the fan of the radiator 242. The ECU 500 can receive a signal indicating a temperature of the secondary battery 30 from a battery temperature sensor 510 that measures the temperature of the secondary battery 30 via a signal line. The ECU 500 can receive a signal indicating a temperature of the coolant via a signal line from a first coolant temperature sensor 511 that measures a temperature of the coolant before the coolant enters the radiator 242 (or the coolant after the coolant has passed through the heat generation portion 250).

### Flowchart

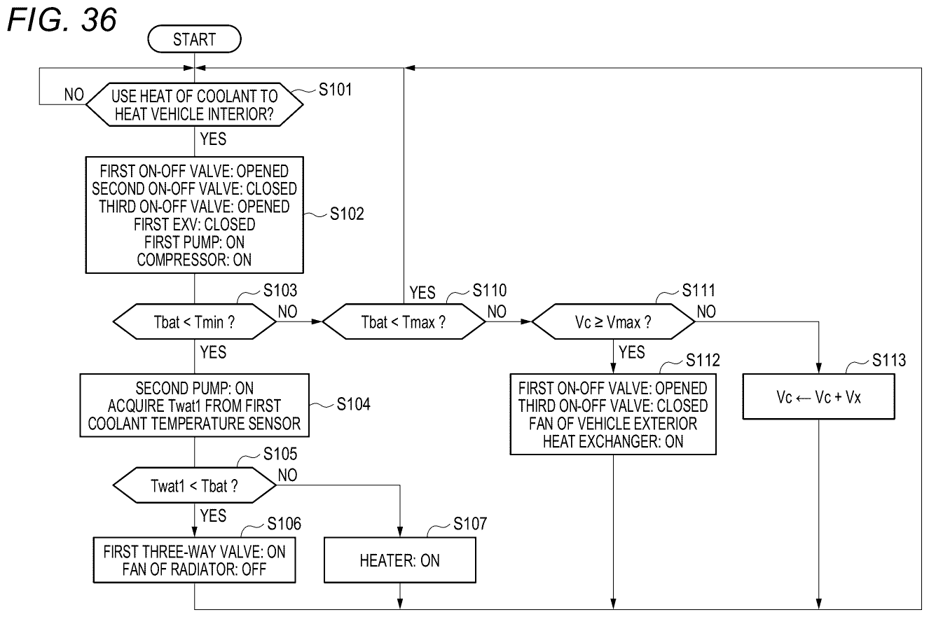

FIG. 36 is a flowchart showing an example of a process performed by the ECU 500 of the heat management system according to the first embodiment. The ECU 500 may achieve the above-described operation patterns by performing the process illustrated in FIG. 36.

The ECU 500 determines whether to use the heat of the coolant when the heating is performed in the vehicle interior (S101).

When the heat of the coolant is not used for heating the vehicle interior (S101: NO), the ECU 500 repeats processing of step S101.

When the heat of the coolant is used for heating the vehicle interior (S101: YES), the ECU 500 causes the processing to proceed to next step S102.

The ECU 500 closes the first on-off valve 331, closes the second on-off valve 332, opens the third on-off valve 333, closes the first EXV 341, turns on the first pump 221, and turns on the compressor 321 (S102). This corresponds to the operation pattern shown in each of FIGS. 9, 18, and 27.

The ECU 500 acquires a battery temperature Tbat of the secondary battery 30 from

the battery temperature sensor 510, and determines whether “the battery temperature Tbat<a battery lower limit temperature Tmin” (S103). The battery lower limit temperature Tmin is a predetermined value, for example, 5 degrees.

Next, a case in which “the battery temperature Tbat<the battery lower limit temperature Tmin” is satisfied (S103: YES) will be described.

The ECU 500 turns on the second pump 222 and acquires a coolant temperature Twat1 of the coolant before the coolant enters the radiator 242 from the first coolant temperature sensor 511 (S104).

The ECU 500 determines whether “the coolant temperature Twat1>the battery temperature Tbat” is satisfied (S105).

When “the coolant temperature Twat1>the battery temperature Tbat” is satisfied (S105: YES), the ECU 500 turns on the first three-way valve 231 and turns off the fan of the radiator 242 (S106). This corresponds to the operation pattern shown in each of FIGS. 11, 20, and 29. Further, the ECU 500 causes the processing to return to step S101.

When “the coolant temperature Twat1≤the battery temperature Tbat” is satisfied (S105: NO), the ECU 500 turns on the heater 240 (S107). This corresponds to the operation pattern shown in each of FIGS. 10, 19, and 28. Further, the ECU 500 causes the processing to return to step S101.

Next, a case in which “the battery temperature Tbat≥the battery lower limit temperature Tmin” is satisfied in step S103 (S103: NO) will be described.

The ECU 500 determines whether “the battery temperature Tbat<a battery upper limit temperature Tmax” is satisfied (S110). The battery upper limit temperature Tmax is a predetermined value, for example, 40 degrees.

When “the battery temperature Tbat<the battery upper limit temperature Tmax” is satisfied (S110: YES), the ECU 500 causes the processing to return to step S101.

When “the battery temperature Tbat≥the battery upper limit temperature Tmax” is satisfied (S110: NO), the ECU 500 determines whether “a compressor rotation speed Vc≥a compressor upper limit rotation speed Vmax” is satisfied (S111). The compressor upper limit rotation speed Vmax is a predetermined value, for example, 8300 rpm.

When “the compressor rotation speed Vc≥the compressor upper limit rotation speed Vmax” is satisfied (S111: YES), the ECU 500 opens the first on-off valve 331, closes the third on-off valve 333, and turns on the fan of the vehicle exterior heat exchanger 323 (S112). This corresponds to the operation pattern shown in each of FIGS. 12, 21, and 30. Further, the ECU 500 causes the processing to return to step S101.

When “the compressor rotation speed Vc<the compressor upper limit rotation speed Vmax” is satisfied (S111: NO), the ECU 500 sets the compressor rotation speed Vc to “Vc+a compressor rotation increase speed Vx” (S113). The compressor rotation increase speed Vx is a predetermined value, for example, 100 rpm. That is, the ECU 500 increases the compressor rotation speed. Further, the ECU 500 causes the processing to return to step S101.

According to the above process, the ECU 500 can switch the operation patterns of the refrigerant circuit 310 and the coolant circuit 210 depending on the temperature of the secondary battery 30 to appropriately adjust the temperature of the secondary battery 30, and heat the vehicle interior using the refrigerant shared with the refrigerant layer 300 through the heat exchange with the coolant and/or heat pump heating.

### Summary of First Embodiment

The following techniques are disclosed from the above description of the first embodiment.

### Technique A1

A vehicle including:
a vehicle body;
a vehicle interior disposed inside the vehicle body;
a first wheel and a second wheel coupled to the vehicle body;
a secondary battery disposed along a predetermined plane in the vehicle body;
a heat exchange plate disposed along the predetermined plane in the vehicle body;
an electric motor configured to drive at least the first wheel using electric power supplied from the secondary battery; and
a refrigerant circuit which includes at least a compressor and a vehicle interior condenser capable of exchanging heat with air in the vehicle interior, and in which a refrigerant is movable between the compressor and the vehicle interior condenser, in which
the heat exchange plate includes:
   a refrigerant input portion that allows the refrigerant that has exited from the vehicle interior condenser of the refrigerant circuit to enter the heat exchange plate and a refrigerant output portion that allows the refrigerant to enter the compressor from the heat exchange plate; and
   a first coolant input and output portion that allows a coolant to be input to and output from the heat exchange plate, and a second coolant input and output portion that allows the coolant to be input to and output from the heat exchange plate,
in the heat exchange plate, the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the coolant that has exited from the first coolant input and output portion of the heat exchange plate is capable of entering the second coolant input and output portion, and
the refrigerant circulates through at least the compressor, the vehicle interior condenser, the heat exchange plate, and the compressor, such that heat generated by the secondary battery is used to warm the air in the vehicle interior.

### Technique A2

The vehicle according to the technique A1, in which
the refrigerant circuit further includes a vehicle exterior heat exchanger between the vehicle interior condenser and the refrigerant input portion of the heat exchange plate,
the refrigerant is movable between the compressor, the vehicle interior condenser, the vehicle exterior heat exchanger, and the refrigerant input portion, and
the refrigerant circulates through at least the compressor, the vehicle interior condenser, the vehicle exterior heat exchanger, the heat exchange plate, and the compressor, such that heat outside the vehicle and the heat generated by the secondary battery are used to warm the air in the vehicle interior.

### Technique A3

The vehicle according to the technique Al or A2, further including:
a coolant circuit in which the coolant that has exited from the first coolant input and output portion of the heat exchange plate returns to the second coolant input and output portion, in which
the coolant circuit includes at least a pump and a heater that heats the coolant using electrical energy,
the coolant circulates through the heat exchange plate and the heater in the coolant circuit, and
the refrigerant circulates through at least the compressor, the vehicle interior condenser, the heat exchange plate, and the compressor, such that the heat generated by the secondary battery and heat generated by the heater are used to warm the air in the vehicle interior.

### Technique A4

The vehicle according to the technique Al or A2, further including:
a coolant circuit in which the coolant that has exited from the first coolant input and output portion of the heat exchange plate returns to the second coolant input and output portion, in which
the coolant circuit includes at least a pump and an electric motor heat exchanger that heats the coolant using heat generated by the electric motor,
the coolant circulates through the heat exchange plate and the electric motor heat exchanger in the coolant circuit,
the refrigerant circulates through at least the compressor, the vehicle interior condenser, the heat exchange plate, and the compressor, such that the heat generated by the secondary battery and the heat generated by the electric motor are used to warm the air in the vehicle interior.

### Technique A5

The vehicle according to the technique A3 or A4, in which
the coolant circuit includes at least one of:
an inverter heat exchanger that exchanges heat with an inverter that converts DC power of the secondary battery into AC power that drives the electric motor;
a converter heat exchanger that exchanges heat with a converter that converts AC power generated by regeneration of the electric motor into DC power used for charging the secondary battery;
a charger heat exchanger that exchanges heat with a charger that charges the secondary battery using external electric power; and
an ECU heat exchanger that exchanges heat with an ECU that performs information processing related to the vehicle.

### Technique A6

A heat management system mountable on a vehicle,
the vehicle including:
a vehicle body;
a vehicle interior disposed inside the vehicle body;
a first wheel and a second wheel coupled to the vehicle body;
a secondary battery disposed along a predetermined plane in the vehicle body; and
an electric motor that drives at least the first wheel using electric power supplied from the secondary battery,
the heat management system including:
a heat exchange plate disposed along the predetermined plane in the vehicle body; and
a refrigerant circuit which includes at least a compressor and a vehicle interior condenser capable of exchanging heat with air in the vehicle interior, and in which a refrigerant is movable between the compressor and the vehicle interior condenser, in which
the heat exchange plate includes:
   a refrigerant input portion that allows the refrigerant that has exited from the vehicle interior condenser of the refrigerant circuit to enter the heat exchange plate and a refrigerant output portion that allows the refrigerant to enter the compressor from the heat exchange plate; and
   a first coolant input and output portion that allows a coolant to be input to and output from the heat exchange plate, and a second coolant input and output portion that allows the coolant to be input to and output from the heat exchange plate,
the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the coolant that has exited from the first coolant input and output portion of the heat exchange plate is capable of entering the second coolant input and output portion, and
the refrigerant circulates through at least the compressor, the vehicle interior condenser, the heat exchange plate, and the compressor, such that heat generated by the secondary battery is used to warm the air in the vehicle interior.

### Technique A7

The heat management system according to the technique A6, in which
the refrigerant circuit further includes a vehicle exterior heat exchanger between the vehicle interior condenser and the refrigerant input portion of the heat exchange plate,
the refrigerant is movable in the compressor, the vehicle interior condenser, the vehicle exterior heat exchanger, and the refrigerant input portion, and
the refrigerant circulates through at least the compressor, the vehicle interior condenser, the vehicle exterior heat exchanger, the heat exchange plate, and the compressor, such that heat outside the vehicle and the heat generated by the secondary battery are used to warm the air in the vehicle interior.

### Technique A8

The heat management system according to the technique A6 or A7, further including:
a coolant circuit in which the coolant that has exited from the first coolant input and output portion of the heat exchange plate returns to the second coolant input and output portion, in which
the coolant circuit includes at least a pump and a heater that heats the coolant using electrical energy,
the coolant circulates through the heat exchange plate and the heater in the coolant circuit, and
the refrigerant circulates through at least the compressor, the vehicle interior condenser, the heat exchange plate, and the compressor, such that the heat generated by the secondary battery and heat generated by the heater are used to warm the air in the vehicle interior.

### Technique A9

The heat management system according to the technique A6 or A7, further including:
a coolant circuit in which the coolant that has exited from the first coolant input and output portion of the heat exchange plate returns to the second coolant input and output portion, in which
the coolant circuit includes at least a pump and an electric motor heat exchanger that heats the coolant using heat generated by the electric motor,
the coolant circulates through the heat exchange plate and the electric motor heat exchanger in the coolant circuit, and
the refrigerant circulates through at least the compressor, the vehicle interior condenser, the heat exchange plate, and the compressor, such that the heat generated by the secondary battery and the heat generated by the electric motor are used to warm the air in the vehicle interior.

### Technique A10

The heat management system according to the technique A8 or A9, in which
the coolant circuit includes at least one of:
an inverter heat exchanger that exchanges heat with an inverter that converts DC power of the secondary battery into AC power that drives the electric motor;
a converter heat exchanger that exchanges heat with a converter that converts AC power generated by regeneration of the electric motor into DC power used for charging the secondary battery;
a charger heat exchanger that exchanges heat with a charger that charges the secondary battery using external electric power; and
an ECU heat exchanger that exchanges heat with an ECU that performs information processing related to the vehicle.

### Second Embodiment

In a second embodiment, a vehicle, a heat management system, and a vehicle control method that can share a refrigerant between the hybrid type heat exchange plate 100 and a vehicle interior air conditioner will be described. In particular, in the hybrid type heat exchange plate 100, in the case in which the secondary battery 30 is heated by using a coolant, heat of the coolant is prevented from being taken away by the refrigerant, and a technology for efficiently heating the secondary battery 30 will be described. In the second embodiment, the same reference numerals are given to constituent elements described in the first embodiment, and description thereof may be omitted.

### System Configuration

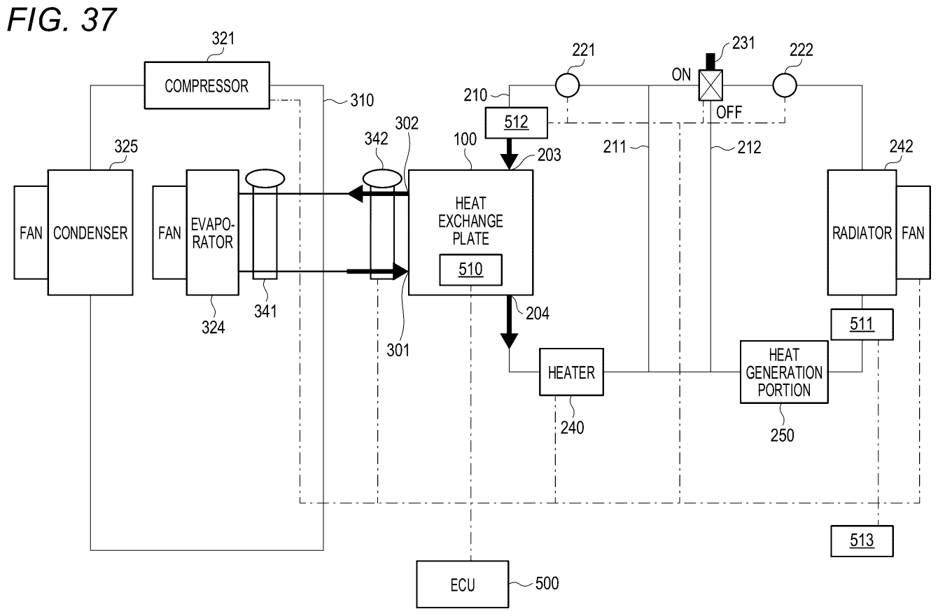

FIG. 37 is a diagram illustrating a configuration example of the heat management system according to the second embodiment.

The heat management system according to the second embodiment includes the refrigerant circuit 310, the coolant circuit 210, the heat exchange plate 100, and the ECU 500.

The refrigerant circuit 310 includes the compressor 321, a condenser 325, the evaporator 324, and the refrigerant input portion 301 and the refrigerant output portion 302 of the refrigerant layer 300 in the heat exchange plate 100.

The refrigerant circuit 310 further includes the first EXV 341 that is disposed between the condenser 325 and the evaporator 324 and controls a flow rate of the refrigerant entering the evaporator 324 (or exiting from the evaporator 324). In the present embodiment, reducing the flow rate of refrigerant entering the evaporator 324 (or exiting from the evaporator 324) to 0 or substantially 0 may be referred to as closing the first EXV 341.

The refrigerant circuit 310 further includes the second EXV 342 that controls a flow rate of the refrigerant entering the refrigerant input portion 301 (or exiting from the refrigerant output portion 302). In the present embodiment, reducing the flow rate of the refrigerant entering the refrigerant input portion 301 (or exiting from the refrigerant output portion 302) to 0 or substantially 0 may be referred to as closing the second EXV 342.

The coolant circuit 210 includes the first pump 221, the coolant input portion 203 and the coolant output portion 204 of the coolant layer 200 in the heat exchange plate 100, the heater 240, the heat generation portion 250, the radiator 242, the second pump 222, and the first three-way valve 231. The heat generation portion 250 is a device provided in the vehicle 1, which performs heat exchange with a device that generates heat during operation. The heat generation portion 250 may include, for example, at least one of the electric motor heat exchanger 251 that performs heat exchange with an electric motor, the charger heat exchanger 252 that performs heat exchange with a charger, the inverter heat exchanger 253 that exchanges heat with an inverter, the converter heat exchanger 254 that exchanges heat with a converter, and the ECU heat exchanger 255 that exchanges heat with the ECU 500.

The coolant circuit 210 further includes the first branch coolant path 211 that connects a position between the first three-way valve 231 and the first pump 221 and a position between the heater 240 and the heat generation portion 250.

The coolant circuit 210 further includes the second branch coolant path 212 that connects the first three-way valve 231 with a position between the heater 240 and the heat generation portion 250 which is closer to the heat generation portion 250 than the first branch coolant path 211.

When the first three-way valve 231 is turned on, a path from the second pump 222 to the first pump 221 is opened and a path to the second branch coolant path 212 is closed. When the first three-way valve 231 is turned off, the path to the second branch coolant path 212 is opened, and the path from the second pump 222 to the first pump 221 is closed.

As shown in FIG. 37, the ECU 500 can control on and off (control the number of rotations) of the compressor 321, and on and off of the second EXV 342 via signal lines indicated by dashed lines in FIG. 37. The ECU 500 can control, via signal lines, on and off of the first pump 221, on and off of the second pump 222, on and off of the heater 240, on and off of the first three-way valve 231, and on and off of the fan of the radiator 242. The ECU 500 can receive a signal indicating a temperature of the secondary battery 30 from the battery temperature sensor 510 that measures the temperature of the secondary battery 30 via a signal line. The ECU 500 can receive a signal indicating a temperature of the coolant from the first coolant temperature sensor 511 that measures a temperature of the coolant before the coolant enters the radiator 242 (or the coolant after the coolant has passed through the heat generation portion 250). The ECU 500 can receive a signal indicating the temperature of the coolant via a signal line from a second coolant temperature sensor 512 that measures the temperature of the coolant before the coolant enters the coolant input portion 203. The ECU 500 can receive a signal indicating an outside air temperature via a signal line from an outside air temperature sensor 513 that measures a temperature of air outside the vehicle.

When cooling is performed in the vehicle interior, the refrigerant circuit 310 turns on the compressor 321, opens the first EXV 341, and turns on a fan of the evaporator 324. At this time, by controlling the opening and closing of the second EXV 342 to adjust a flow rate of the refrigerant input to the refrigerant layer 300 (output from the refrigerant layer 300), the refrigerant can be shared for cooling the secondary battery 30.

On the other hand, when the secondary battery 30 is heated, the coolant circuit 210 may turn on the first pump 221, turn on the heater 240, and turn off the first three-way valve 231, for example. In this case, the coolant circulates through the first pump 221, the coolant input portion 203, the coolant layer 200, the coolant output portion 204, the heater 240, and the first branch coolant path 211 in this order. The coolant can warm the secondary battery 30 in the coolant layer 200 by using heat obtained from the heater 240 being turned on. Alternatively, when the secondary battery 30 is heated, the coolant circuit 210 may turn on the first pump 221, turn off the heater 240, and turn on the first three-way valve 231, for example. In this case, the coolant circulates through the first pump 221, the coolant input portion 203, the coolant layer 200, the coolant output portion 204, the heater 240, the heat generation portion 250, the radiator 242, the second pump 222, and the first three-way valve 231 in this order. The coolant can warm the secondary battery 30 in the coolant layer 200 by using heat obtained from the heat generation portion 250.

However, in a case in which the refrigerant enters the refrigerant layer 300 when the air in the vehicle interior is cooled, the refrigerant absorbs heat from the coolant, and efficiency of heating the secondary battery 30 by the coolant is reduced.

Therefore, in the present embodiment, when the secondary battery 30 is heated while the cooling is perform in the vehicle interior, the refrigerant is appropriately discharged from the refrigerant layer 300. Accordingly, the refrigerant can be prevented in the refrigerant layer 300 from taking the heat from the coolant, and the coolant can efficiently heat the secondary battery 30. Next, a discharge timing of the refrigerant will be described in detail.

### Discharge Timing of Refrigerant

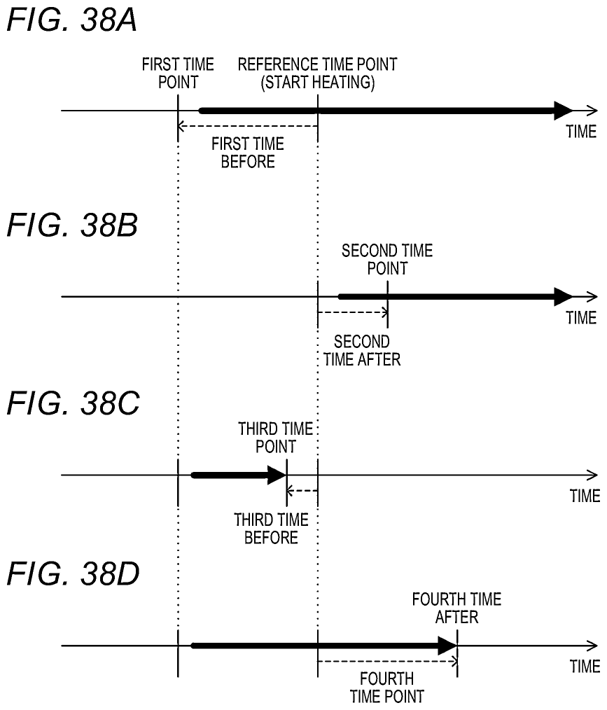

FIGS. 38A to 38D are a diagram illustrating a discharge timing of the refrigerant according to the second embodiment.

In the present embodiment, a time point at which heat generated by the heat generation portion 250 starts to be used for heating the secondary battery 30 via the coolant flowing through the coolant circuit 210 and the heat exchange plate 100 is set as a reference time point. In FIGS. 38A to 38D, thick arrows indicate discharge periods of the refrigerant.

As shown in FIG. 38A, the ECU 500 may start to discharge the refrigerant of the heat exchange plate 100 to the refrigerant circuit 310 between the reference time point and a first time point a first time before the reference time point. Alternatively, as shown in FIG. 38B, the ECU 500 may start to discharge the refrigerant of the heat exchange plate 100 to the refrigerant circuit 310 between the reference time point and a second time point a second time after the reference time point.

As shown in FIG. 38C, the ECU 500 may complete the discharge of the refrigerant

of the heat exchange plate 100 to the refrigerant circuit 310 between the reference time point and a third time point a third time before the reference time point, the third time being shorter than the first time. Alternatively, as shown in FIG. 38D, the ECU 500 may complete the discharge of the refrigerant of the heat exchange plate 100 to the refrigerant circuit 310 between the reference time point and a fourth time point a fourth time after the reference time point.

According to the above processing, when the heated coolant heats the secondary battery 30, the refrigerant is discharged from the refrigerant layer 300 at an appropriate timing and for an appropriate period of time, thereby preventing the refrigerant from taking the heat away from the coolant at the heat exchange plate 100. Accordingly, the coolant in the coolant layer 200 can efficiently heat the secondary battery 30.

### Flowchart

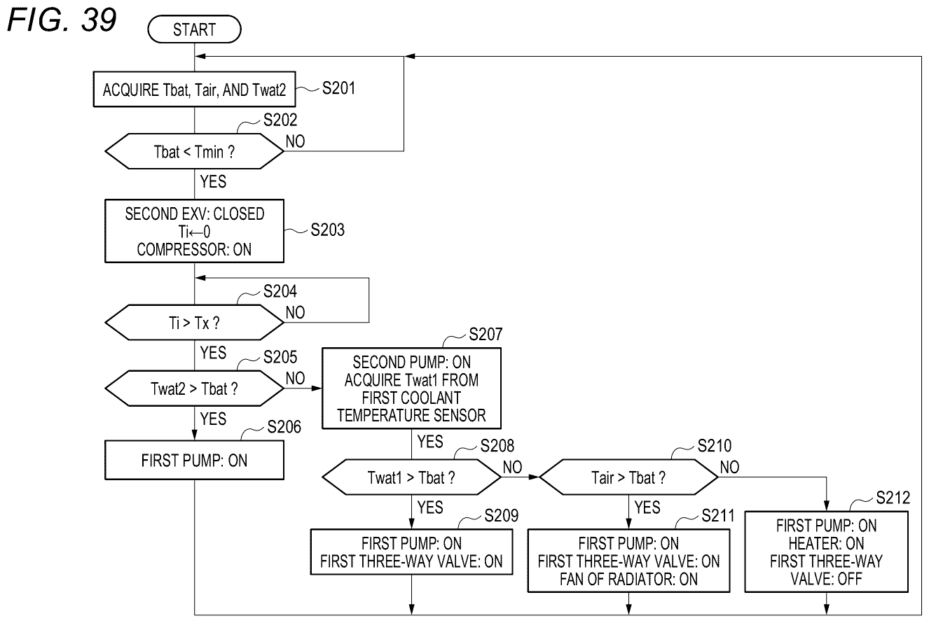

FIG. 39 is a flowchart showing an example of a process performed by the ECU 500 of the heat management system according to the second embodiment.

The ECU 500 acquires the battery temperature Tbat from the battery temperature sensor 510, an outside air temperature Tair from the outside air temperature sensor 513, and a coolant temperature Twat2 of the coolant entering the coolant input portion 203 from the second coolant temperature sensor 512 (S201).

The ECU 500 determines whether “the battery temperature Tbat<the battery lower limit temperature Tmin” is satisfied (S202). The battery lower limit temperature Tmin is a predetermined value, for example, 5 degrees.

When “the battery temperature Tbat≥the battery lower limit temperature Tmin” is satisfied (S202: NO), the ECU 500 causes the processing to return to step S201.

When “the battery temperature Tbat<the battery lower limit temperature Tmin” is satisfied (S202: YES), the ECU 500 closes the second EXV 342, initializes an elapsed time Ti to 0, and turns on the compressor 321 (S203). That is, the ECU 500 restricts the refrigerant flowing into the refrigerant input portion 301 by the second EXV 342, and operates the compressor 321 to discharge the refrigerant of the heat exchange plate 100 to the refrigerant circuit 310.

The ECU 500 determines whether “the elapsed time Ti>a refrigerant recovery operation time Tx” is satisfied (S204). The refrigerant recovery operation time Tx is a predetermined value, for example, one minute. Alternatively, the refrigerant recovery operation time Tx may be a time indicated by a thick arrow in FIG. 35. The elapsed time Ti increases with time.

When “the elapsed time Ti≤the refrigerant recovery operation time Tx” is satisfied (S204: NO), the ECU 500 repeats step S204. Accordingly, the refrigerant is discharged from the refrigerant layer 300 and recovered in the compressor 321.

When “the elapsed time Ti>the refrigerant recovery operation time Tx” is satisfied (S204: YES), the ECU 500 determines whether “the coolant temperature Twat2 of the coolant entering the coolant input portion 203>the battery temperature Tbat” is satisfied (S205).

When “the coolant temperature Twat2 of the coolant entering the coolant input portion 203>the battery temperature Tbat” is satisfied (S205: YES), the ECU 500 turns on the first pump 221 (S206). Accordingly, the secondary battery 30 is heated by the coolant of which the temperature is higher than the battery temperature Tbat. Further, the ECU 500 causes the processing to return to step S201.

When “the coolant temperature Twat2 of the coolant entering the coolant input portion 203≤the battery temperature Tbat” is satisfied (S205: NO), the ECU 500 turns on the second pump 222 and obtains the coolant temperature Twat1 of the coolant entering the radiator 242 from the first coolant temperature sensor 511 (S207). The coolant entering the radiator 242 is heated by the heat generated by the heat generation portion 250.

The ECU 500 determines whether “the coolant temperature Twat1 of the coolant entering the radiator 242>the battery temperature Tbat” is satisfied (S208).

When “the coolant temperature Twat1 of the coolant entering the radiator 242>the battery temperature Tbat” is satisfied (S208: YES), the ECU 500 turns on the first pump 221 and turns on the first three-way valve 231 (S209). That is, when a battery temperature Tat of the secondary battery 30 is below a predetermined threshold (for example, the battery lower limit temperature Tmin), the ECU 500 may use the heat generated by the heat generation portion 250 to start to heat the secondary battery 30 via the coolant flowing through the coolant circuit 210 and the heat exchange plate 100. In other words, the first pump 211 feeds the coolant heated by using the heat generated by the heat generation portion 250 to the coolant input portion 203. At this time, the ECU 500 may prevent or stop the rotation of the fan provided in the radiator 242 compared to when the coolant is not used for heating the secondary battery 30. This is to prevent the coolant heated by using the heat generated by the heat generation portion 250 from being cooled by the fan of the radiator 242. Accordingly, the secondary battery 30 can be heated by the coolant having a temperature higher than the battery temperature Tbat, which is heated by using the heat generated by the heat generation portion 250. Further, the ECU 500 causes the processing to return to step S201.

When “the coolant temperature Twat1 of the coolant entering the radiator 242≤the battery temperature Tbat” (S208: NO), the ECU 500 determines whether “the outside air temperature Tair>the battery temperature Tbat” is satisfied (S210).

When “the outside air temperature Tair>the battery temperature Tbat” is satisfied (S210: YES), the ECU 500 turns on the first pump 221, turns on the fan of the radiator 242, and turns on the first three-way valve 231 (S211). Accordingly, the secondary battery 30 is heated by the coolant that is warmed by the outside air temperature Tair that is higher than the battery temperature Tbat. Further, the ECU 500 causes the processing to return to step S201.

When “the outside air temperature Tair≤ the battery temperature Tbat” is satisfied (S210: NO), the ECU 500 turns on the first pump 221, turns on the heater 240, and turns off the first three-way valve 231 (S212). In this case, the coolant circulates through the first pump 221, the coolant input portion 203, the coolant layer 200, the coolant output portion 204, the heater 240, and the first branch coolant path 211. Accordingly, the secondary battery 30 can be heated by the coolant heated by the heater 240. In this case, the coolant heated by the heat generated by the heat generation portion 250 may not be used for heating the secondary battery 30, and may circulate through the radiator 242, the second pump 222, the first three-way valve 231, the second branch coolant path 212, and the heat generation portion 250. That is, when the heat generated by the heat generation portion 250 is not used for heating the secondary battery 30 via the coolant flowing through the coolant circuit 210 and the heat exchange plate 100, the coolant circuit 210 may have a flow path through which the coolant output from the radiator 242 returns to the radiator 242 without being input to the coolant input portion 203. Further, the ECU 500 causes the processing to return to step S201.

According to the above process, the coolant can be appropriately heated in the coolant circuit 210 according to a situation, and the secondary battery 30 can be efficiently heated in the coolant layer 200.

### Modification

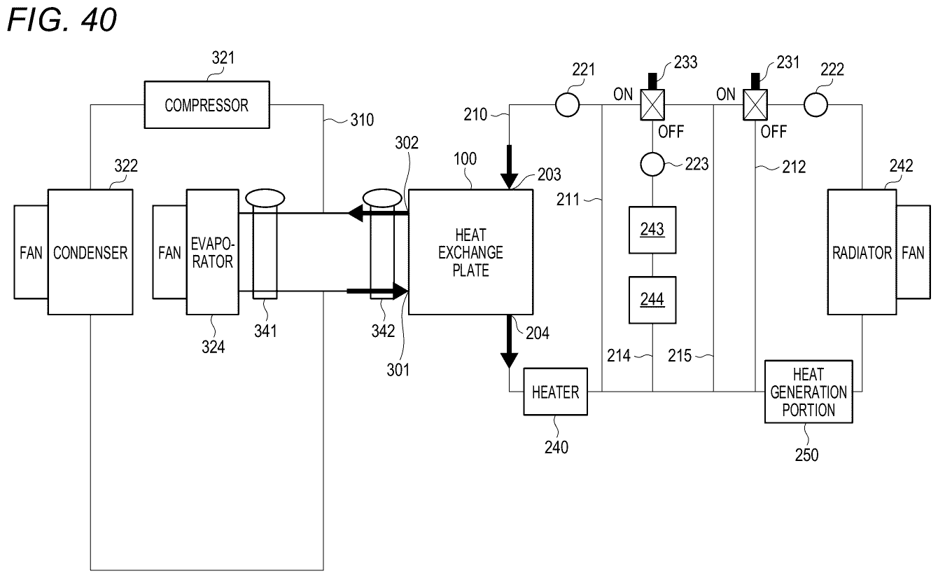

FIG. 40 is a diagram showing a modification of a configuration of the heat management system according to the second embodiment. For the coolant circuit 210, the following constituent elements may be added to the coolant circuit 210 shown in FIG. 37.

The coolant circuit 210 further includes a third three-way valve 233 located between the first pump 221 and the first three-way valve 231 and between the first branch coolant path 211 and the second branch coolant path 212.

The coolant circuit 210 further includes a fourth branch coolant path 214 that connects a position between the heater 240 and the second branch coolant path 212 to the third three-way valve 233.

The coolant circuit 210 further includes a fifth branch coolant path 215 that connects a position between the first three-way valve 231 and the third three-way valve 233 and a position between the heater 240 and the heat generation portion 250 and between the second branch coolant path 212 and the fourth branch coolant path 214.

A third pump 223, a heater 243, and a heater core 244 are disposed in the fourth branch coolant path 214. The heater 243 generates heat using electrical energy and is capable of heating a coolant passing through the fourth branch coolant path 214. The heater core 244 is a heat exchanger that is provided in an air conditioner inside the vehicle interior and performs heat exchange between a relatively high-temperature coolant passing through the fourth branch coolant path 214 and a relatively low-temperature air inside the vehicle interior to generate warm air at an appropriate temperature.

The coolant circuit 210 according to the modification shown in FIG. 40 can also

warm the coolant, so that the warmed coolant can be used for heating the secondary battery 30 in the coolant layer 200.

### Summary of Second Embodiment

The following techniques are disclosed from the above description of the second embodiment.

### Technique B1

A vehicle including:
a vehicle body;
a first wheel and a second wheel coupled to the vehicle body;
a secondary battery disposed along a predetermined plane in the vehicle body;
a heat exchange plate disposed along the predetermined plane in the vehicle body; and
an electric motor configured to drive at least the first wheel using electric power supplied from the secondary battery, in which
the heat exchange plate includes:
   a refrigerant input portion that allows a refrigerant to enter the heat exchange plate and a refrigerant output portion that allows the refrigerant to exit from the heat exchange plate; and
   a first coolant input and output portion that allows a coolant to be input to and output from the heat exchange plate, and a second coolant input and output portion that allows the coolant to be input to and output from the heat exchange plate,
in the heat exchange plate, the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the vehicle further includes:
   a refrigerant circuit which is connected to the refrigerant input portion and the refrigerant output portion and includes at least a compressor and a condenser, and in which the refrigerant flows; and
   a coolant circuit that is connected to the first coolant input and output portion and the second coolant input and output portion and through which the coolant flows at least to the heat generation portion, and
a time point at which heat generated by the heat generation portion starts to be used for heating the secondary battery via the coolant flowing through the coolant circuit and the heat exchange plate is set as a reference time point, and the refrigerant of the heat exchange plate starts to be discharged into the refrigerant circuit between the reference time point and a first time point a first time before the reference time point, or between the reference time point and a second time point a second time after the reference time point.

### Technique B2

The vehicle according to the technique B1, further including:
a control circuit, in which
the control circuit starts to discharge the refrigerant of the heat exchange plate to the refrigerant circuit between the reference time point and the first time point the first time before the reference time point or between the reference time point and the second time point the second time after the reference time point.

### Technique B3

The vehicle according to the technique B1 or B2, in which
the heat generation portion is at least one of:
a heater that generates heat using electric power;
an electric motor heat exchanger capable of exchanging heat with the electric motor;
a charger heat exchanger capable of exchanging heat with a charger that charges the secondary battery using electric power from an outside of the vehicle; and
an inverter heat exchanger capable of exchanging heat with an inverter that converts DC power from the secondary battery into AC power to be supplied to the electric motor.

### Technique B4

The vehicle according to any one of the techniques B1 to B3, in which
the time point at which the heat generated by the heat generation portion starts to be used for heating the secondary battery via the coolant flowing through the coolant circuit and the heat exchange plate is set as the reference time point, and the refrigerant of the heat exchange plate starts to be discharged into the refrigerant circuit between the reference time point and the first time point the first time before the reference time point, and
the discharge of the refrigerant of the heat exchange plate into the refrigerant circuit is completed between the reference time point and a third time point a third time before the reference time point, the third time being shorter than the first time.

### Technique B5

The vehicle according to any one of the techniques B1 to B3, in which
the time point at which the heat generated by the heat generation portion starts to be used for heating the secondary battery via the coolant flowing through the coolant circuit and the heat exchange plate is set as the reference time point, and the refrigerant of the heat exchange plate starts to be discharged into the refrigerant circuit between the reference time point and the first time point the first time before the reference time point, and
the discharge of the refrigerant of the heat exchange plate into the refrigerant circuit is completed between the reference time point and a fourth time point a fourth time after the reference time point.

### Technique B6

The vehicle according to any one of the techniques B1 to B5, further including:
a valve disposed in the refrigerant circuit between the condenser and the refrigerant input portion and capable of adjusting an inflow rate input to the refrigerant input portion, in which
the refrigerant flowing into the refrigerant input portion is prevented by the valve, and the refrigerant of the heat exchange plate is discharged into the refrigerant circuit by operating the compressor.

### Technique B7

The vehicle according to any one of the techniques B1 to B6, in which
when a temperature of the secondary battery is less than a predetermined threshold value, the heat generated by the heat generation portion starts to be used for heating the secondary battery via the coolant flowing through the coolant circuit and the heat exchange plate.

### Technique B8

The vehicle according to any one of the techniques B1 to B7, in which
the coolant circuit includes a pump, and
the pump feeds the coolant heated by using the heat generated by the heat generation portion to the first coolant input and output portion or the second coolant input and output portion.

### Technique B9

The vehicle according to any one of the techniques B1 to B8, in which
the coolant circuit further includes a radiator to which the coolant heated by using the heat generated by the heat generation portion is input,
the coolant output from the radiator is input to the first coolant input and output portion, and
when the heat generated by the heat generation portion is used for heating the secondary battery via the coolant flowing through the coolant circuit and the heat exchange plate, rotation of a fan provided in the radiator is prevented compared to when the heating is not performed.

### Technique B10

The vehicle according to the technique B9, in which
when the heat generated by the heat generation portion is not used for heating the secondary battery via the coolant flowing through the coolant circuit and the heat exchange plate, the coolant circuit has a flow path through which the coolant output from the radiator returns to the radiator without being input to the first coolant input and output portion.

### Technique B11

A vehicle control method available for a vehicle, in which
the vehicle includes:
   a vehicle body;
   a first wheel and a second wheel coupled to the vehicle body;
   a secondary battery disposed along a predetermined plane in the vehicle body;
   a heat exchange plate disposed along the predetermined plane in the vehicle body; and
   an electric motor that drives at least the first wheel using electric power supplied from the secondary battery,
the heat exchange plate includes:
   a refrigerant input portion that allows a refrigerant to enter the heat exchange plate and a refrigerant output portion that allows the refrigerant to exit from the heat exchange plate; and
   a first coolant input and output portion that allows a coolant to be input to and output from the heat exchange plate, and a second coolant input and output portion that allows the coolant to be input to and output from the heat exchange plate,
in the heat exchange plate, the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the vehicle further includes:
   a refrigerant circuit which is connected to the refrigerant input portion and the refrigerant output portion and includes at least a compressor and a condenser, and in which the refrigerant flows; and
   a coolant circuit that is connected to the first coolant input and output portion and the second coolant input and output portion and through which the coolant flows at least to the heat generation portion, and
the vehicle control method includes:
   setting a time point at which heat generated by the heat generation portion starts to be used for heating the secondary battery via the coolant flowing through the coolant circuit and the heat exchange plate as a reference time point, and starting to discharge the refrigerant of the heat exchange plate into the refrigerant circuit between the reference time point and a first time point a first time before the reference time point, or between the reference time point and a second time point a second time after the reference time point.

### Technique B12

The vehicle control method according to the technique B11, in which
the vehicle further includes a control circuit.

### Technique B13

The vehicle control method according to the technique B11 or B12, in which
the heat generation portion is at least one of:
a heater that generates heat using electric power;

an electric motor heat exchanger capable of exchanging heat with the electric motor;
a charger heat exchanger capable of exchanging heat with a charger that charges the secondary battery using electric power from an outside of the vehicle; and
an inverter heat exchanger capable of exchanging heat with an inverter that converts

DC power from the secondary battery into AC power to be supplied to the electric motor.

### Technique B14

The vehicle control method according to any one of the techniques B11 to B13, in which
the time point at which the heat generated by the heat generation portion starts to be used for heating the secondary battery via the coolant flowing through the coolant circuit and the heat exchange plate is set as the reference time point, and the refrigerant of the heat exchange plate starts to be discharged into the refrigerant circuit between the reference time point and the first time point the first time before the reference time point, and
the discharge of the refrigerant of the heat exchange plate into the refrigerant circuit is completed between the reference time point and a third time point a third time before the reference time point, the third time being shorter than the first time.

### Technique B15

The vehicle control method according to any one of the techniques B11 to B14, in which
the time point at which the heat generated by the heat generation portion starts to be used for heating the secondary battery via the coolant flowing through the coolant circuit and the heat exchange plate is set as the reference time point, and the refrigerant of the heat exchange plate starts to be discharged into the refrigerant circuit between the reference time point and the first time point the first time before the reference time point, and
the discharge of the refrigerant of the heat exchange plate into the refrigerant circuit is completed between the reference time point and a fourth time point a fourth time after the reference time point.

### Technique B16

The vehicle control method according to any one of the techniques B11 to B15, in which
the refrigerant circuit further includes a valve disposed between the condenser and the refrigerant input portion and capable of adjusting an inflow rate input to the refrigerant input portion, and
the refrigerant flowing into the refrigerant input portion is prevented by the valve, and the refrigerant of the heat exchange plate is discharged into the refrigerant circuit by operating the compressor.

### Technique B17

The vehicle control method according to any one of the techniques B11 to B16, in which
when a temperature of the secondary battery is less than a predetermined threshold value, the heat generated by the heat generation portion starts to be used for heating the secondary battery via the coolant flowing through the coolant circuit and the heat exchange plate.

### Technique B18

The vehicle control method according to any one of the techniques B11 to B17, in which
the coolant circuit includes a pump, and
the pump feeds the coolant heated by using the heat generated by the heat generation portion to the first coolant input and output portion or the second coolant input and output portion.

### Technique B19

The vehicle control method according to any one of the techniques B11 to B18, in which
the coolant circuit further includes a radiator to which the coolant heated by using the heat generated by the heat generation portion is input,
the coolant output from the radiator is input to the first coolant input and output portion, and
when the heat generated by the heat generation portion is used for heating the secondary battery via the coolant flowing through the coolant circuit and the heat exchange plate, rotation of a fan provided in the radiator is prevented compared to when the heating is not performed.

### Technique B20

The vehicle control method according to the technique B19, in which
when the heat generated by the heat generation portion is not used for heating the secondary battery via the coolant flowing through the coolant circuit and the heat exchange plate, the coolant circuit has a flow path through which the coolant output from the radiator returns to the radiator without being input to the first coolant input and output portion.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiments described above may be freely combined without departing from the gist of the invention.

The present application is based on Japanese Patent Application No. 2022-170010 and Japanese Patent Application No. 2022-170011 filed on Oct. 24, 2022, and the contents of which are incorporated herein by reference.

What is claimed is:

1. A vehicle comprising:
a vehicle body;
a vehicle interior disposed inside the vehicle body;
a first wheel and a second wheel coupled to the vehicle body;
a secondary battery disposed along a predetermined plane in the vehicle body;
a heat exchange plate disposed along the predetermined plane in the vehicle body;
an electric motor configured to drive at least the first wheel using electric power supplied from the secondary battery; and
a refrigerant circuit which includes at least a compressor and a vehicle interior condenser capable of exchanging heat with air in the vehicle interior, and in which a refrigerant is movable between the compressor and the vehicle interior condenser, wherein
the heat exchange plate includes:
a refrigerant input portion that allows the refrigerant that has exited from the vehicle interior condenser of the refrigerant circuit to enter the heat exchange plate and a refrigerant output portion that allows the refrigerant to enter the compressor from the heat exchange plate; and
a first coolant input and output portion that allows a coolant to be input to and output from the heat exchange plate, and a second coolant input and output portion that allows the coolant to be input to and output from the heat exchange plate,
in the heat exchange plate, the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the coolant that has exited from the first coolant input and output portion of the heat exchange plate is capable of entering the second coolant input and output portion, and
the refrigerant circulates through at least the compressor, the vehicle interior condenser, the heat exchange plate, and the compressor, such that the heat generated by the secondary battery is used to warm the air in the vehicle interior.

2. The vehicle according to claim 1, wherein
the refrigerant circuit further includes a vehicle exterior heat exchanger between the vehicle interior condenser and the refrigerant input portion of the heat exchange plate,
the refrigerant is movable between the compressor, the vehicle interior condenser, the vehicle exterior heat exchanger, and the refrigerant input portion, and
the refrigerant circulates through at least the compressor, the vehicle interior condenser, the vehicle exterior heat exchanger, the heat exchange plate, and the compressor, such that heat outside the vehicle and the heat generated by the secondary battery are used to warm the air in the vehicle interior.

3. The vehicle according to claim 1, further comprising:
a coolant circuit in which the coolant that has exited from the first coolant input and output portion of the heat exchange plate returns to the second coolant input and output portion, wherein
the coolant circuit includes at least a pump and a heater that heats the coolant based on electrical energy,
the coolant circulates through the heat exchange plate and the heater in the coolant circuit, and
the refrigerant circulates through at least the compressor, the vehicle interior condenser, the heat exchange plate, and the compressor, such that the heat generated by the secondary battery and heat generated by the heater are used to warm the air in the vehicle interior.

4. The vehicle according to claim 1, further comprising:
a coolant circuit in which the coolant that has exited from the first coolant input and output portion of the heat exchange plate returns to the second coolant input and output portion, wherein
the coolant circuit includes at least a pump and an electric motor heat exchanger that heats the coolant based on heat generated by the electric motor, and
the coolant circulates through the heat exchange plate and the electric motor heat exchanger in the coolant circuit, the refrigerant circulates through at least the compressor, the vehicle interior condenser, the heat exchange plate, and the compressor, such that the heat generated by the secondary battery and the heat generated by the electric motor are used to warm the air in the vehicle interior.

5. The vehicle according to claim 4, wherein
the coolant circuit includes at least one of:
an inverter heat exchanger that exchanges heat with an inverter that converts DC power of the secondary battery into AC power that drives the electric motor;
a converter heat exchanger that exchanges heat with a converter that converts AC power generated by regeneration of the electric motor into DC power used for charging the secondary battery;
a charger heat exchanger that exchanges heat with a charger that charges the secondary battery based on external electric power; and
an ECU heat exchanger that exchanges heat with an ECU that performs information processing related to the vehicle.

6. A heat management system mountable on a vehicle,
the vehicle including:
a vehicle body;
a vehicle interior disposed inside the vehicle body;
a first wheel and a second wheel coupled to the vehicle body;
a secondary battery disposed along a predetermined plane in the vehicle body; and
an electric motor that drives at least the first wheel using electric power supplied from the secondary battery,
the heat management system comprising:
a heat exchange plate disposed along the predetermined plane in the vehicle body; and
a refrigerant circuit which includes at least a compressor and a vehicle interior condenser capable of exchanging heat with air in the vehicle interior, and in which a refrigerant is movable between the compressor and the vehicle interior condenser, wherein
the heat exchange plate includes:
a refrigerant input portion that allows the refrigerant that has exited from the vehicle interior condenser of the refrigerant circuit to enter the heat exchange plate and a refrigerant output portion that allows the refrigerant to enter the compressor from the heat exchange plate; and
a first coolant input and output portion that allows a coolant to be input to and output from the heat exchange plate, and a second coolant input and output portion that allows the coolant to be input to and output from the heat exchange plate,
the refrigerant that has entered from the refrigerant input portion is set to exit from the refrigerant output portion, the coolant that has entered from the first coolant input and output portion is set to exit from the second coolant input and output portion, and the coolant that has entered from the second coolant input and output portion is set to exit from the first coolant input and output portion,
the refrigerant is capable of exchanging heat with the coolant in the heat exchange plate, and the heat exchange plate is capable of exchanging heat with the secondary battery,
the coolant that has exited from the first coolant input and output portion of the heat exchange plate is capable of entering the second coolant input and output portion, and
the refrigerant circulates through at least the compressor, the vehicle interior condenser, the heat exchange plate, and the compressor, such that the heat generated by the secondary battery is used to warm the air in the vehicle interior.

7. The heat management system according to claim 6, wherein
the refrigerant circuit further includes a vehicle exterior heat exchanger between the vehicle interior condenser and the refrigerant input portion of the heat exchange plate,
the refrigerant is movable between the compressor, the vehicle interior condenser, the vehicle exterior heat exchanger, and the refrigerant input portion, and
the refrigerant circulates through at least the compressor, the vehicle interior condenser, the vehicle exterior heat exchanger, the heat exchange plate, and the compressor, such that heat outside the vehicle and the heat generated by the secondary battery are used to warm the air in the vehicle interior.

8. The heat management system according to claim 6, further comprising:
a coolant circuit in which the coolant that has exited from the first coolant input and output portion of the heat exchange plate returns to the second coolant input and output portion, wherein
the coolant circuit includes at least a pump and a heater that heats the coolant based on electrical energy,
the coolant circulates through the heat exchange plate and the heater in the coolant circuit, and
the refrigerant circulates through at least the compressor, the vehicle interior condenser, the heat exchange plate, and the compressor, and the heat generated by the secondary battery and heat generated by the heater are used to warm the air in the vehicle interior.

9. The heat management system according to claim 6, further comprising:
a coolant circuit in which the coolant that has exited from the first coolant input and output portion of the heat exchange plate returns to the second coolant input and output portion, wherein
the coolant circuit includes at least a pump and an electric motor heat exchanger that heats the coolant based on heat generated by the electric motor,
the coolant circulates through the heat exchange plate and the electric motor heat exchanger in the coolant circuit, and
the refrigerant circulates through at least the compressor, the vehicle interior condenser, the heat exchange plate, and the compressor, such that the heat generated by the secondary battery and the heat generated by the electric motor are used to warm the air in the vehicle interior.

10. The heat management system according to claim 9, wherein
the coolant circuit includes at least one of:
an inverter heat exchanger that exchanges heat with an inverter that converts DC power of the secondary battery into AC power that drives the electric motor;
a converter heat exchanger that exchanges heat with a converter that converts AC power generated by regeneration of the electric motor into DC power used for charging the secondary battery;
a charger heat exchanger that exchanges heat with a charger that charges the secondary battery based on external electric power; and
an ECU heat exchanger that exchanges heat with an ECU that performs information processing related to the vehicle.
